(19) United States
(12) Patent Application Publication
(10) Pub. No.: US 2025/0148445 A1
(43) Pub. Date: May 8, 2025

(54) SALES INFORMATION AGGREGATION AND PROCESSING SYSTEM AND SALES INFORMATION AGGREGATION AND PROCESSING METHOD

(71) Applicant: Toshiba Tec Kabushiki Kaisha, Tokyo (JP)

(72) Inventors: Yoichiro YAMADA, Numazu Shizuoka (JP); Yukio NAGARA, Suginami Tokyo (JP); Masahito SANO, Fuji Shizuoka (JP); Shin YOSHIDA, Ota Tokyo (JP); Taishi SANO, Yokohama Kanagawa (JP); Satoru ISHIHARA, Koto Tokyo (JP)

(21) Appl. No.: 18/924,524

(22) Filed: Oct. 23, 2024

(30) Foreign Application Priority Data
Nov. 2, 2023 (JP) 2023-188421

(51) Int. Cl. G06Q 20/20

(52) U.S. Cl. CPC G06Q 20/202

(57) ABSTRACT

According to one embodiment, an information processing system for sales data aggregation and analysis includes a server with a communication interface connected to a network, a storage device, and a processor. The processor is configured to receive point-of-sale data from a plurality point-of-sale devices via the network and store the point-of-sale data in the storage device and receive receipt data from an electronic receipt server via the network and store the receipt data in the storage device. The processor can generate display information based on stored point-of-sale data or based on stored receipt data. The processor may also generate display information based on both the stored point-of-sale data and the stored receipt data. The processor can transmit the generated display information to a user terminal via the network.

### CROSS-REFERENCE TO RELATED APPLICATION

This application is based upon and claims the benefit of priority from Japanese Patent Application No. 2023-188421, filed Nov. 2, 2023, the entire contents of which are incorporated herein by reference.

### FIELD

Embodiments described herein relate to a sales information aggregation and processing system and a sales information aggregation and processing method.

### BACKGROUND

Aggregated transaction data related to purchases by customers at a retail store or stores can be used to analyze store sales or customer purchase trends. Such information for analysis may be referred to as sales data, aggregated transaction information, trend data, sales trend data, or the like. For such purposes, retail stores may provide or send transaction data to different data service operators or vendors who may provide an analysis of the accumulated data, which may be referred to as an analysis product, an analysis solution, or an analytic solution.

However, typically, only an analysis on the transaction data of the retail store(s) that a particular retailer operates is available. Although such an analysis may be sufficient for understanding transactions at a retail store that the retailer operates, t is typically not sufficient for understanding transactions and trends of the public at large, such as may be related to setting of an appropriate price for certain products or judging the trends in popularity of commodities. This wider transaction data may be useful for selecting and pricing new products for a store.

### BRIEF DESCRIPTION OF THE DRAWINGS

FIG. 1 is a block diagram schematically showing a configuration example of a server according to an embodiment.

FIG. 2 is a diagram showing an example of a data structure of second POS data.

FIG. 3 is a diagram showing an example of a data structure of receipt data.

FIG. 4 is a flowchart showing an example of collection processing of second POS data.

FIG. 5 is a flowchart showing another example of collection processing.

FIG. 6 is a flowchart showing an example of collection processing of receipt data.

FIG. 7 is a flowchart showing an example of output processing of display information.

FIG. 8 is a flowchart showing an example of second generation processing.

FIG. 9 is a diagram showing an example of a screen image for inputting a first extraction condition for a first type content.

FIG. 10 depicts a chart related to display of aggregated sales data.

FIG. 11 is a diagram showing an example of a screen image for inputting a second extraction condition for a second type content.

FIG. 12 is a diagram showing an example of a screen image of a first example of second type content.

FIG. 13A is a diagram showing an example of a screen image of a second example of second type content.

FIG. 13B is a diagram showing another example of a screen image of second type content.

FIG. 14 is a diagram showing an example of a screen image of a third example of second type content.

FIG. 15 is a flowchart showing another example of the output processing.

FIG. 16 is a flowchart showing an example of setting processing of the first extraction condition.

FIG. 17 is a diagram showing an example of an image for inputting the first extraction condition.

FIG. 18 is a flowchart showing an example of setting processing of the second extraction condition.

FIG. 19 is a diagram showing an example of a screen image for inputting the second extraction condition.

FIG. 20 is a flowchart showing an example of setting processing of use authority.

FIG. 21 is a diagram showing an example of screen image for inputting use authority for another vendor.

### DETAILED DESCRIPTION

In general, according to one embodiment, devices, systems, and methods for supporting comparisons between transaction data of an organization and other publicly available transaction data is provided.

According to one embodiment, an information processing system includes a server. The server has a storage device, a communication interface connectable to a network, and a processor. The processor is configured to receive point-of-sale data from a plurality point-of-sale devices via the network and store the point-of-sale data in the storage device; receive receipt data from an electronic receipt server via the network and store the receipt data in the storage device; generate display information based on stored point-of-sale data; generate display information based on stored receipt data; generate display information based on both the stored point-of-sale data and the stored receipt data; and transmit generated display information to a user terminal via the network.

### Embodiments

Hereinafter, certain example embodiments will be described with reference to the drawings. In the drawings, the depicted dimensions, scale, relative sizing and the like of each aspect may vary for those of an implemented embodiment. The aspects may be omitted from the drawings for the sake of simplified description of relevant aspects.

### Configuration Example

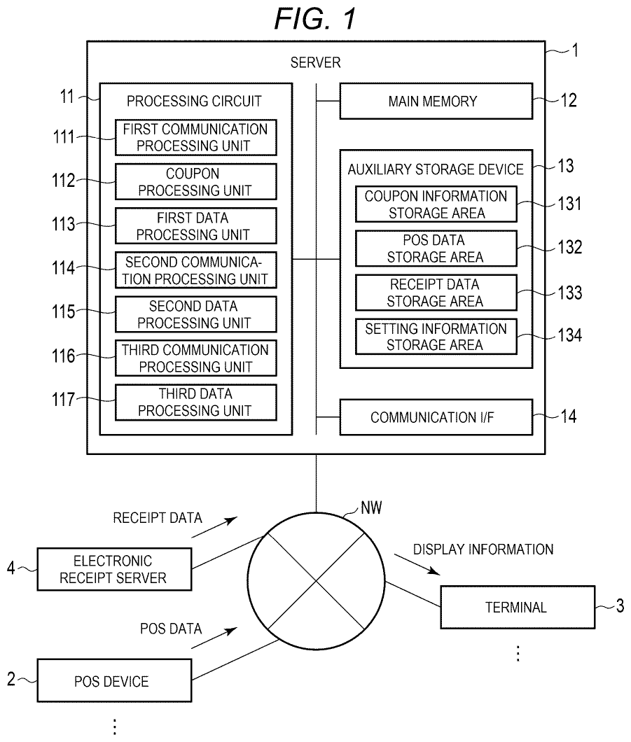

FIG. 1 is a block diagram schematically showing a configuration example of a server 1 for a multiuser sales data analysis system.

The server 1 is a device that supports distribution between point of sales (POS) data and receipt data. For example, the server 1 provides a cloud service related to data distribution.

In this context, “POS data” is transaction data collected from a POS device 2. The transaction data is data related to a transaction commodity (a commodity involved in a sales transaction). The POS data can be data for an individual transaction commodity or several. The POS data is generated by the POS device 2 based on transaction processing performed by the POS device 2. The POS data can be initially data stored in the POS device 2. The POS data can be referred to in the following as first transaction data.

In the present context, a transaction commodity can be any commodity, item, product, merchandise, service, or the like sold at a store. In general, the transaction involves a customer picking up an item, registering the item in the transaction, then paying for the item at a POS device 2 or the like. The transaction is a purchase transaction from the viewpoint of a customer and sales transaction from the viewpoint of a store. A sales commodity is any commodity sold at a store. The commodity may be a physical commodity or an intangible commodity, such as a service or a ticket for a service or the like. The customer purchase may involve a customer in-person visit to a store or an online store (online purchase, web purchase, or the like). As such, the store in an embodiment may be a physical store or an electronic commerce (EC) store. The store may be operated by a retailer. The retailer is a vendor that operates the store. The retailer may be of any type. The retailer may operate a store that sells commodities of many types, such as a supermarket or a convenience store. The retailer may operate a store that sells commodities of a specific type. The retailer may operate multiple stores, a store chain, a multiple vendor market, or the like. A retailer group is a group that operates stores that are recognized as affiliated even if not all of the same individual brand or the like. For example, a retailer group operates stores under the same name and may include franchisees with which the retailer engages as a franchisor. The retailer is an example of an organization.

The POS data includes data of various types and details. For example, the POS data may include or not a member number, a store code, a terminal number, a transaction number, a transaction date, a transaction time point, a commodity code, a unit price, a quantity sold, and a transaction amount. The POS data may include other information beyond or different from these items.

In this context, a member number is a code capable of uniquely identifying a customer as a member of a retail business program (e.g., a customer loyalty program) operated by a retailer. The store code is a code capable of uniquely identifying a store. The terminal number is a code capable of uniquely identifying the POS device 2 at which a transaction was performed. The transaction number is a code capable of uniquely identifying a particular transaction. The transaction date is a calendar date when a transaction occurred. The transaction time point is of the time (e.g., hh:mm:ss) when the transaction occurred. The commodity code is a code capable of uniquely identifying a commodity. The unit price is a price paid per transacted commodity. Hereinafter, information regarding a unit price included in the POS data is also referred to as a transaction price. In this context, the “quantity” item in the transaction data refers to the number of transacted commodities of the same type in a transaction, this is also referred to as a transacted quantity. The “amount” item in the transaction data is the amount (money) due for all the commodities in a transaction and may be referred to as a transaction total or transaction total amount. The transaction amount may generally be obtained by multiplying the unit price and the transacted quantity for each of the different commodities in the transaction and summing the values for every commodity in the transaction.

In this context, “receipt data” is transaction data providing purchase history data indicating a purchase history of a customer, that is items purchased by the customer in one or a series of transactions. The receipt data may be certified by a retailer at which a customer purchases commodities. The receipt data can be generated or provided as data for constructing a sales receipt. The sales receipt provides details of a transaction and may be dispensed upon completion of the sales transaction. For example, details of the transaction on a receipt (on in receipt data) include information related to transacted commodities, information indicating the store in which the transaction was performed, and information indicating a transaction date and time. The details of the transaction in the receipt data may include information other than the above information. The information related to the transacted commodity may include all or a part of the name of the commodity, the transaction price, the transaction quantity, and the transaction amount obtained by multiplying the transaction price and the transaction quantity. The information related to the transacted commodity may include information other than the above information. The information related to the store in which the transaction is performed can be a name of the store. The information related to the store in which the transaction was performed may include information other than the above information. The information related to the transaction date and time includes the transaction date and time. The information related to the transaction date and time may include information other than the above information. The sales receipt may be an electronic receipt capable of being displayed as an image on a terminal or may be a paper receipt. The receipt data may be referred to as second transaction data.

In general, the receipt data includes various items. For example, the receipt data can include a member ID, a member number, a terminal number, a transaction number, a transaction date and time, a company code, a company name, a store code, a store name, a commodity code, a commodity name, a unit price, a quantity, a classification code, a classification level, and a total amount of receipt (transaction total). The receipt data may include data of items other than these items.

If the receipt is an electronic receipt, the member ID may be a code capable of uniquely identifying a customer as a member of an electronic receipt service. In some examples, the member number may be a code capable of uniquely identifying a customer as a member of a store loyalty program or the like. The terminal number is a code capable of uniquely identifying the POS device 2 that processed the transaction. The transaction number is a code capable of uniquely identifying a transaction. The transaction date and time is the date and time of a transaction. The company code is a code capable of uniquely identifying a retailer who operates a store. The company name is a name of a retailer. The store code is a code capable of uniquely identifying a particular store. The store name is a name of a store. The commodity code is a code capable of uniquely identifying a commodity involved in a transaction. The commodity name is a name of a commodity. The unit price is a price per transacted commodity of the same commodity code or the like. Hereinafter, the unit price included in the receipt data can also be referred to as a transaction price. The quantity is the number of transacted commodities. Hereinafter, the quantity included in the receipt data is also referred to as a transaction quantity. The classification code is a code used in the commodity distribution industry to represent a classification or category of commodities. The classification level is a level in a classification system. The total amount of receipt is a total amount obtained by summing up transaction amounts of transacted commodities included in the sales transaction.

The server 1 provides content and display information to a terminal 3.

The display information can be displayed on the terminal 3. For example, the display information is image information for displaying content on the terminal 3. The display information may be information for displaying content in a table format or in a graph format. The display format for the content is not limited thereto. The content may be displayed in one display area or distributed among a plurality of display areas. The display area is any screen area or the like for displaying content. The display area may be for a graph or a table, or may be a browser window or the like. The possible display areas are not limited thereto.

The content is content to be displayed or the like. The content may be a first type content and a second type content. In this context, first type content and second type content are examples of content that may be displayed to a user or the like.

The first type content is generated by the server 1 based on a plurality of pieces of POS data. The first type content is content related to transaction performance (“first transaction performance information”). Here, first transaction performance information can be a value obtained based on aggregation of the plurality of pieces of POS data. For example, the first transaction performance information corresponds to all transaction performance at a specific retailer or multiple retailers. The aggregation of POS data is a process of collecting a plurality of pieces of POS data.

In one example, the value obtained based on the aggregation of the plurality of pieces of POS data can be an aggregation value (aggregated value) based on a summing or collection of any item value included in the pieces of POS data. The aggregation value may be a value obtained by summing up values of any items included in the plurality of pieces of POS data. For example, the aggregation value is a value obtained by summing up the transaction amount, the transaction price, or the transaction quantity, but is not limited thereto. The aggregation value may be a value obtained by counting any unique item entries (values) included in the plurality of pieces of POS data. For example, the aggregation value can be the total number of unique customers obtained by counting the different member numbers in the POS data, but is not limited thereto. The aggregation value may be a corrected value. For example, a correction of a value can be rounding, but is not limited thereto. The correction may be any calculation for changing, processing, or manipulating a value. Rounding is an example of calculation processing for changing a value according to set rules. The rounding processing may be rounding up, rounding down, and rounding off, but is not limited thereto.

In another example, the value obtained based on the aggregation of the plurality of pieces of POS data is a statistical value based on an aggregation of values of one or more items. The statistical value can be a value obtained by calculation. For example, the statistical value may be an average value, a difference, a ratio, or the like, but is not limited thereto. The statistical value may be a corrected value.

For first type content, the display information is generated based on first processing data. The first processing data is data generated based on the aggregation of the plurality of pieces of POS data. The first processing data can include the first transaction performance information. The first transaction performance information can include aggregation values. The first transaction performance information can include a statistical value.

The second type content can be generated by the server 1 based on a plurality of pieces of POS data and a plurality of pieces of receipt data. The second type content is content related to the first transaction performance information and second transaction performance information. The second transaction performance information is obtained based on aggregation of a plurality of pieces of receipt data. For example, the second transaction performance information corresponds to transaction performance information for the public beyond a specific store or retailer. The aggregation of the plurality of pieces of receipt data is a process of collecting the plurality of pieces of receipt data. The second transaction performance information is an example of information representing the performance of transactions.

A value obtained based on the aggregation of the plurality of pieces of receipt data can be an aggregation value (aggregated value) of any item values included in the receipt data. The aggregation value can be obtained by summing up values of any item included in the plurality of pieces of receipt data. For example, the aggregation value is obtained by summing up the transaction amounts, the transaction prices, and the transaction quantities, but is not limited thereto. The aggregation value may be obtained by counting unique values of any item included in the plurality of pieces of receipt data. For example, the aggregation value can be the total number of customers obtained by counting unique member numbers, but is not limited thereto.

In another example, a statistical value based on an aggregation value of one or more items in the receipt data may be obtained. The statistical value may be obtained by calculation on an aggregation value for one or more items in the receipt data. For example, the statistical value is an average value, a difference, a ratio, or the like, but is not limited thereto.

For the second type content, the display information is generated based on both the first processing data and second processing data. The second processing data is data generated based on the aggregation of a plurality of pieces of receipt data. The second processing data can include the second transaction performance information. The second transaction performance information can include aggregation values. The second transaction performance information can include a statistical value.

The server 1 is communicably connected to the POS device 2 via a network NW. The network NW includes one or more networks such as the Internet, a mobile communication network, and a local area network (LAN). The LAN may be a wireless LAN or a wired LAN. Although FIG. 1 shows one POS device 2, the server 1 communicates with a plurality of POS devices 2.

The server 1 is communicably connected to the terminal 3 via the network NW. Although FIG. 1 shows one terminal 3, the server 1 communicates with a plurality of terminals 3.

The server 1 is communicably connected to an electronic receipt server 4 via the network NW. Although FIG. 1 shows one electronic receipt server 4, the server 1 may communicate with a plurality of electronic receipt servers 4.

The server 1 may be implemented as one device or may be implemented as a plurality of devices in which functions are distributed. The server 1 is an example of an information processing system implemented by one device or a plurality of devices. The information processing system implemented by one device is also referred to as an information processing device.

The POS device 2 processes a sales transaction and generates transaction data. For example, the POS device 2 has a settlement function for processing payments for settling a transaction. In some examples, POS device 2 may additionally or instead have a commodity registration. The POS device 2 may be a device installed in a store or may be a device that provides a cloud-based service without necessarily being in the store.

The terminal 3 can be any terminal device capable of displaying information. The terminal 3 can be a tablet terminal, a smartphone, a personal computer (PC), or the like, but is not limited thereto.

The electronic receipt server 4 stores a plurality of pieces of receipt data for a plurality of electronic receipts. For example, the electronic receipt server 4 dispenses an electronic receipt for each transaction. The electronic receipt server 4 stores, for the dispensed electronic receipt, the receipt data for each transaction commodity.

A configuration example of the server 1 will be described.

The server 1 includes a processing circuit 11, a main memory 12, an auxiliary storage device 13, and a communication interface 14. In FIG. 1, the interface is described as “I/F”.

The processing circuit 11 corresponds to a central part of the server 1. The processing circuit 11 includes one or more circuits that execute a plurality of processing using a plurality of functions. For example, the circuit is a processor, an application specific integrated circuit (ASIC), or a field-programmable gate array (FPGA), but is not limited thereto. For example, the processor is a central processing unit (CPU) or a graphics processing unit (GPU), but is not limited thereto. The processing circuit 11 loads a program stored in advance in the main memory 12 or the auxiliary storage device 13 into the main memory 12. The program is a software program for causing the processing circuit 11 to execute processing to be described later. The processing circuit 11 executes the program loaded in the main memory 12 to enable execution of various types of described processing.

The main memory 12 can comprise a nonvolatile memory area and a volatile memory area. The main memory 12 stores an operating system or a program in the nonvolatile memory area. The main memory 12 uses the volatile memory area as a work area in which data is appropriately rewritten by the processing circuit 11. For example, the main memory 12 includes a read only memory (ROM) as the nonvolatile memory area. For example, the main memory 12 includes a random access memory (RAM) as the volatile memory area.

The auxiliary storage device 13 can be one or more storage devices. Examples of the storage device include an electric erasable programmable read-only memory (EEPROM), a hard disc drive (HDD), a solid-state drive (SSD), and a flash memory, but are not limited thereto. The auxiliary storage device 13 stores the program, data used by the processing circuit 11 to perform various types of processing, and data generated by the processing in the processing circuit 11. Each storage area of the auxiliary storage device 13 may be in one device or may be distributed among a plurality of devices. Each storage area is an example of a storage unit of the server 1.

The auxiliary storage device 13 includes a coupon information storage area 131. The coupon information storage area 131 stores coupon information about coupons that might be or have been used in a transaction. The coupon provides a benefit useful for a customer. Examples of the coupon include free exchange of commodities, discount, and reward point granting, but are not limited thereto. The coupon information is information indicating such things as a value, a use eligibility condition, valid dates, and the like of a coupon. The coupon information may be correlated to a coupon dispensing condition. The coupon dispensing condition is a condition set for the dispensing of a coupon to a customer or the like. For example, the coupon dispensing condition relates to purchase of a particular transaction commodity or the transaction amount threshold, but is not limited thereto. Data in the coupon information storage area 131 can be changed by addition, updates, or deletion of the coupon information and/or dispensing conditions. The coupon may be dispensed in a paper form or distributed as electronic data to an e-mail or an application installed in a smartphone.

The auxiliary storage device 13 includes a POS data storage area 132. The POS data storage area 132 stores the POS data (sales transaction data) in a predetermined format. The POS data stored in POS data storage area 132 is generally the POS data acquired by the server 1 from the POS devices 2. The various POS devices 2 may generate or transmit POS data (sales transaction data) in a format different than the predetermined format. The POS data may be supplied from the POS devices 2 on a per transaction basis. The predetermined format is a predetermined data format. The predetermined format does not depend on the software executed by the particular POS device 2 that originally generated the POS data. The predetermined format can be appropriately set by an operator or administrator of the server 1. Hereinafter, the POS data in the format acquired by the server 1 from a POS device 2 is also referred to as first POS data (or first-type POS data). The POS data in the predetermined format is referred to as second POS data (or second-type POS data). The first POS data and the second POS data are examples of transaction data. Data in the POS data storage area 132 can be updated by adding or deleting the second POS data.

The auxiliary storage device 13 includes a receipt data storage area 133. The receipt data storage area 133 stores the receipt data acquired by the server 1 on a per transaction commodity basis. Data in the receipt data storage area 133 is updated by adding or deleting the receipt data.

The auxiliary storage device 13 includes a setting information storage area 134. The setting information storage area 134 stores setting information.

In one example, the setting information storage area 134 stores setting information related to an extraction condition that has been previously set by a retailer or the like. The extraction condition can be a first-type extraction condition or a second-type extraction condition. The first-type extraction condition relates to the first type content. The second-type extraction condition relates to the second type content.

The setting information relating to a first-type extraction condition is information indicating an extraction condition set for the second POS data stored in the POS data storage area 132.

The first extraction condition may limit extracted information to a store owned by a specific retailer or all stores owned by the specific retailer may be in the target range of the extraction. The target range of the retailer may be all stores owned by the specific retailer. For example, the extraction condition may limit to a specific business category or classification among all stores owned by the specific retailer. In this context, the business category is a grouping or the like such as supermarkets, home centers, convenience stores, or pharmacies. The transaction data may be extracted for stores in specific area, geographic region, or the like from among all stores owned by a specific retailer. The specific area of concern may be a region or an area such as the Kanto region or the Kansai region, a prefecture, or a city, a ward, a town, or a village. Transaction data for a single store from among all stores owned by a specific retailer may be extracted. The processing circuit 11 can extract, based on store code data included in the second POS data, the data satisfying the conditions related to a store owned by a specific retailer.

The extraction condition may be related to a transaction commodity.

The extraction condition may be related to a single, specific commodity (e.g., same commodity code), a grouping of commodities, a specific type or class of commodity, commodity price, or the like. The commodity can be a physical commodity such as food or clothing or a service, a ticket, or the like. The target range of the commodity may be a commodity of a specific commodity type. For example, a commodity type can be any classification or grouping such as clothing and food. The processing circuit 11 can extract information related to specific commodities based on commodity code data included in the second POS data.

The first extraction condition may include a condition related to a transaction time, a transaction date, a time period, or the like. Such a time period may be referred to as an evaluation period, analysis period, or the like. Extraction conditions related to times, dates, and periods may be set arbitrarily. The processing circuit 11 can extract such information based on transaction time data and/or transaction date data included in the second POS data.

The first extraction condition may be related to a customer attribute. Such attributes may include gender or any customer demographic data. The processing circuit 11 can extract such information based on customer attribute data associated with a member number data included in the second POS data.

Once the first extraction condition is set, the processing circuit 11, at a predetermined timing, generates the display information based on a plurality of pieces of second POS data satisfying the first extraction condition(s). The predetermined timing may be set by the server 1 or may be set by a user. The predetermined timing may be different or may be the same regardless of the first type content selected for display.

The setting information storage area 134 may store the setting information for the first extraction condition(s) for multiple vendors.

Data in the setting information storage area 134 can be updated by adding, changing, or deleting a first extraction condition.

The setting information related to a second extraction condition is information indicating an extraction condition set for extracting particular second POS data and receipt data. The second extraction condition is used for generating display information related to the second type content.

The second extraction condition may be related to a store owned by a specific retailer. The processing circuit 11 can extract, using the store code data included in the second POS data, the second POS data of a store owned by the specific retailer.

The second extraction condition may be related to a particular store owned by a retailer to be compared. The condition can be a comparison range for extracting the receipt data from various other stores or groups of stores including the particular store. The comparison range may encompass stores owned by different retailers. The comparison range may be all stores owned by the plurality of retailers. The comparison range may be limited to a specific business category (type) among all stores owned by the retailers. The comparison range may be limited to a specific business area. The comparison range may be limited to a specific business category within a specific area among all stores owned by a plurality of retailers. The comparison range may be limited to a specific store among all stores available for comparison purposes. The processing circuit 11 can extract, using the store code data included in the receipt data, the receipt data satisfying the extraction condition(s) related to the stores to be compared.

The second extraction condition may be or comprise a condition related to a commodity. A condition related to a commodity can be for extracting second POS data and receipt data. The processing circuit 11 can extract particular transactions or related data based on commodity code data included in the second POS data and/or receipt data. For example, a transactions involving a particular commodity (commodity code) can be extracted.

The second extraction condition may be related to a time period in which the transactions or the like occurred. That is, transactions within particular time ranges or periods can be extracted from the second POS data and the receipt data for comparison purposes. The processing circuit 11 can extract information based on the transaction date data included in the second POS data or the transaction date and time data included in the receipt data.

The second extraction condition may be related to a customer attribute. The conditions related to a customer attribute can be those already described above. The processing circuit 11 can extract information based on customer attribute data associated with member number data included in the second POS data and/or the receipt data.

When the second extraction condition is set, the processing circuit 11 generates, at a predetermined timing, display information based on a plurality of pieces of second POS data and a plurality of pieces of second receipt data satisfying the second extraction condition. The predetermined timing for generation of the display information may be set by the server 1 or may be set by a user. The predetermined timing may be set differently according to the associated second type content or may be the same regardless of the second type content.

The setting information storage area 134 may store the setting information for the second extraction condition for multiple vendors.

Data in the setting information storage area 134 is updated by changing or deleting the second extraction condition(s). A setting f t of the second extraction condition includes not only an example of adding a new setting but also an example of a change.

In another example, the setting information storage area 134 stores use authority setting information for each of the vendors that may access certain data. The use authority setting information is information indicating the use authority (permission) for another vendor set for stored second POS data of a retailer. In this context, another vendor is a different entity from the retailer who initially provided the second POS data. For example, the other vendor can be a product manufacturer or a wholesaler, but is not limited thereto. The other vendor can be any other organization. The use authority is permission to use the second POS data. The use authority may cover multiple stores owned by the retailer. The range of the stores may include an individual store, a business category of the store, or an area of the store. For example, the retailer may provide use authority to another vendor as part of a selling of data to the other vendor.

Data in the setting information storage area 134 is updated by setting or deleting the use authority.

The communication interface 14 communicably connects the server 1 to another device. The communication interface 14 is an example of a communication unit of the server 1.

The hardware configuration of the server 1 is not limited to the above-described configuration. In the server 1, the above-described constituent elements may be appropriately omitted and changed, and other constituent elements may be added thereto.

Functions implemented by the processing circuit 11 will be described.

The processing circuit 11 implements a first communication processing unit 111, a coupon processing unit 112, a first data processing unit 113, a second communication processing unit 114, a second data processing unit 115, a third communication processing unit 116, and a third data processing unit 117. Each unit implemented by the processing circuit 11 can also be referred to as a function. Each unit implemented by the processing circuit 11 can also be considered to be implemented by a control unit, controller, or the like including the processing circuit 11 and the main memory 12.

The first communication processing unit 111 handles communication between the server 1 and the POS device 2 via the communication interface 14. For example, the first communication processing unit 111 acquires the first POS data from the POS device 2 via the communication interface 14. A format of the first POS data generally depends on the POS device 2 that sends the first POS data. In some instances, a POS device 2 may send first POS data already in a predetermined format. For example, the first communication processing unit 111 also outputs coupon information to the POS device 2 via the communication interface 14.

The coupon processing unit 112 can extract coupon information from the coupon information storage area 131 based on the first POS data.

The first data processing unit 113 stores the second POS data in the POS data storage area 132 by converting as necessary or the like the first POS data into the predetermined format of the second POS data.

The second communication processing unit 114 handles communication between the server 1 and the electronic receipt server 4 via the communication interface 14. For example, the second communication processing unit 114 acquires the receipt data from the electronic receipt server 4 via the communication interface 14.

The second data processing unit 115 stores the receipt data acquired by the second communication processing unit 114 in the receipt data storage area 133.

The third communication processing unit 116 handles communication between the server 1 and the terminal 3 via the communication interface 14. For example, the third communication processing unit 116 acquires a request corresponding to an input operation of the terminal 3 performed by the user via the communication interface 14. For example, the third communication processing unit 116 outputs the display information to the terminal 3 via the communication interface 14. The third communication processing unit 116 is an example of a communication processing unit.

The third data processing unit 117 generates the display information. In one example, the third data processing unit 117 generates the display information based on the plurality of pieces of second POS data stored in the POS data storage area 132. In another example, the third data processing unit 117 generates the display information based on the plurality of pieces of second POS data and the plurality of pieces of receipt data. The third data processing unit 117 sets the extraction condition based on the operation of the terminal 3 performed by the user. The third data processing unit 117 sets the use authority of another vendor based on the operation of the terminal 3 performed by the user. The third data processing unit 117 is an example of a data processing unit.

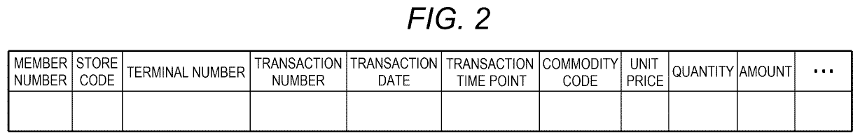

FIG. 2 is a diagram showing an example of a data structure of the second POS data.

In the example, the second POS data includes data for a member number, a store code, a terminal number, a transaction number, a transaction date, a transaction time point, a commodity code, a unit price, a quantity, and an amount.

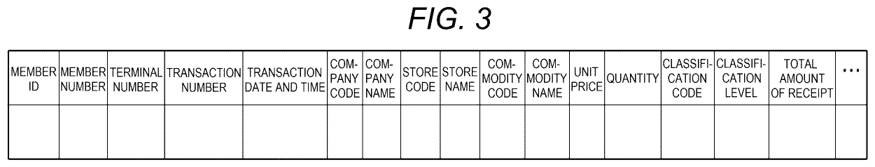

FIG. 3 is a diagram showing an example of a data structure of the receipt data.

In the example, the receipt data includes data for a member ID, a member number, a terminal number, a transaction number, a transaction date and time, a company code, a company name, a store code, a store name, a commodity code, a commodity name, a unit price, a quantity, a classification code, a classification level, and a total amount of receipt.

### Operation Example

Next, processing in the server 1 will be described.

A processing procedure described below is merely an example, and details of the processing may be varied when possible while achieving the same effects. In general, in the processing procedure example described below, acts or steps may be omitted, rearranged, substituted, or replaced, and additional acts or steps can be added thereto as appropriate for implementation of an embodiment.

In the following description, functions implemented by the processing circuit 11 will be mainly described as implemented by “units” implemented by the processing circuit 11 executing software or the like, and the description of each function implemented by a unit of the processing circuit 11 may be considered to be read as implemented by the processing circuit 11 itself.

Two examples of collection processing of the second POS data performed by the processing circuit 11 of the server 1 will be described.

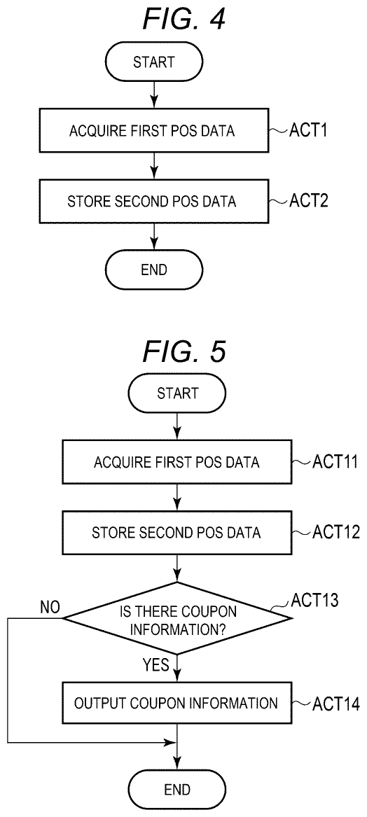

FIG. 4 is a flowchart showing an example of the collection processing of the second POS data performed by the processing circuit 11 of the server 1.

The processing circuit 11 of the server 1 executes the processing shown in FIG. 4 on a per transaction. Each piece of second POS data may be considered associated with a transaction commodity (e.g., a commodity code of an item sold in the underlying transaction).

The first communication processing unit 111 acquires the first POS data (ACT 1). In ACT 1, the first communication processing unit 111 acquires the first POS data from the POS device 2 via the communication interface 14.

The first data processing unit 113 stores the second POS data in the POS data storage area 132 based on the acquired first POS data (ACT 2).

A case in which the format of the first POS data is already the predetermined format will be described. In such an example, the second POS data is exactly the same as the first POS data. Thus, the first data processing unit 113 may store the acquired first POS data already in the predetermined format in the POS data storage area 132 as second POS data without reformatting or conversion processing.

A case in which the format of the first POS data is a format other than the predetermined format will be described. In such an example, the second POS data is data obtained by converting the format of the first POS data. The first data processing unit 113 converts the first POS data into the predetermined format. The first data processing unit 113 generates the second POS data by conversion. The first data processing unit 113 stores the generated second POS data in the POS data storage area 132.

As described above, the server 1 can generate the second POS data by converting the format of the first POS data into the predetermined format.

Accordingly, the server 1 can manage POS data from a plurality of different POS devices 2 in a unified format.

FIG. 5 is a flowchart showing another example of the collection processing of the second POS data performed by the processing circuit 11 of the server 1.

The example shown in FIG. 5 is different from the example shown in FIG. 4 in that the server 1 acquires the first POS data from the POS device 2 as part of an inquiry for the coupon information.

The processing circuit 11 of the server 1 executes the processing shown in FIG. 4 on a per transaction basis.

The first communication processing unit 111 acquires the first POS data (ACT 11). In ACT 11, the first communication processing unit 111 acquires the first POS data from the POS device 2 as part of an inquiry for coupon information. In this example, the POS device 2 performs the inquiry for the coupon information has a different POS data format from the predetermined format, however, the application software used for inquiring about coupon information from the server 1 is common application software installed in each POS device 2, and therefore the format of the first POS data supplied for inquiring about the coupon information is a common format. The POS device 2 coupon inquiry software thus converts the POS data generated by the POS device 2 to a common first POS data format and stores the data. The POS device 2 then transmits the first POS data (coupon inquiry format) to the server 1.

The first data processing unit 113 stores the second POS data in the POS data storage area 132 based on the first POS data as acquired by the first communication processing unit 111 (ACT 12). The processing in ACT 12 is the same as the processing in ACT 2.

The coupon processing unit 112 extracts the coupon information from the coupon information storage area 131 using the first POS data (ACT 13). In ACT 13, the coupon processing unit 112 compares the transaction commodities or the overall transaction information represented in the first POS data to the coupon dispensing conditions stored in the coupon information storage area 131. If a transaction commodity or the transaction represented by the first POS data satisfies the coupon dispensing condition, the coupon processing unit 112 extracts the coupon information meeting the coupon dispensing condition(s) from the coupon information storage area 131.

If the coupon processing unit 112 extracts coupon information from the coupon information storage area 131 (ACT 13, YES), the processing transitions from ACT 13 to ACT 14. If the coupon processing unit 112 does not extract coupon information from the coupon information storage area 131 (ACT 13, NO), the processing ends.

The first communication processing unit 111 then outputs the coupon information extracted by the coupon processing unit 112 (ACT 14). In ACT 14, the first communication processing unit 111 outputs the coupon information to the POS device 2 via the communication interface 14. When the coupon information is acquired from the server 1, the POS device 2 provides a corresponding coupon to the customer. The POS device 2 may provide the coupon to the customer by dispensing a piece of paper (printed coupon) or may provide the coupon electronically (electronic coupon).

As described above, the server 1 acquires the first POS data output from the POS device 2 as part of the inquiry for the coupon information.

In such a case, the server 1 can collect the first POS data without requiring the retailer to separately upload the first POS data to the server 1. Therefore, the retailer can avoid the work of uploading the first POS data.

The collection processing of the receipt data by the processing circuit 11 of the server 1 will be described.

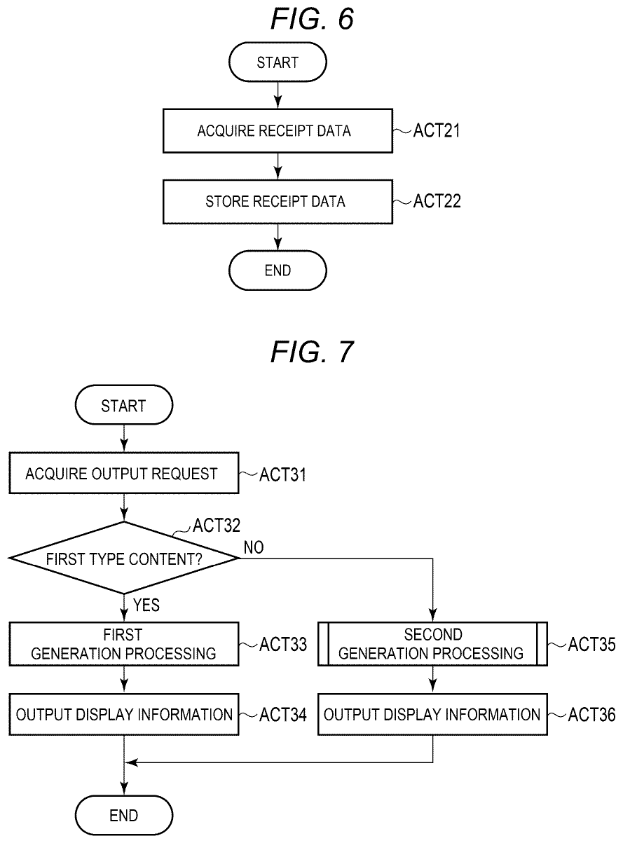

FIG. 6 is a flowchart showing an example of the collection processing of the receipt data performed by the processing circuit 11 of the server 1.

The processing circuit 11 of the server 1 executes the processing shown in FIG. 6 on a per transaction basis at any timing.

The second communication processing unit 114 acquires the receipt data (ACT 21). In ACT 21, the second communication processing unit 114 acquires the receipt data from the electronic receipt server 4 via the communication interface 14.

The second data processing unit 115 stores the receipt data acquired by the second communication processing unit 114 in the receipt data storage area 133 (ACT 22).

In ACT 21, the second communication processing unit 114 may acquire the receipt data from another receipt server different from the electronic receipt server 4 via the communication interface 14. The other receipt server may, for example, store receipt data based on an image taken of a paper receipt provided by a customer using a customer's own terminal or device.

The second communication processing unit 114 may acquire the customer's image data of a paper receipt via the communication interface 14. In the example, the second data processing unit 115 generates the receipt data based on the image data acquired by the second communication processing unit 114. The second data processing unit 115 stores the generated receipt data in the receipt data storage area 133.

As described above, the server 1 can collect this receipt data.

Accordingly, the server 1 can generate information corresponding to the second type content not only by collecting second POS data from POS terminals 2 but also by acquiring customer receipt data (images).

Two examples of output processing of the display information performed by the processing circuit 11 of the server 1 will be described.

FIG. 7 is a flowchart showing an example of the output processing of the display information performed by the processing circuit 11 of the server 1.

Here, a user accesses the server 1 using the terminal 3 in order to display a content image on the terminal 3. In this example, the user of terminal 3 is an employee or the like of a retailer. The user inputs an extraction condition using the terminal 3. For example, it is assumed here that the user inputs a condition related to a store owned by the retailer as a condition related to a store owned by a specific retailer.

When the first type content is being selected from available content, the user inputs a first extraction condition using the terminal 3. The first extraction condition is an extraction condition for extracting second POS data to be used for generating the content display information. If the second type content is being selected from available content, the user inputs a second extraction condition using the terminal 3. The second extraction condition is an extraction condition for extracting second POS data and receipt data to be used for generating content display information. Information indicating the first extraction condition or the second extraction condition can be input using the terminal 3. The input information indicating the extraction condition(s) may also include information indicating the content to be displayed. After inputting an extraction condition, the user provides an output instruction by using the terminal 3. The output instruction is an instruction for causing the server 1 to output the content display information to the terminal 3. The output instruction can also be an instruction to display an image of particular content on the terminal 3. The terminal 3 outputs an output request and the information related to the extraction condition(s) to the server 1. The output request is a request for causing the server 1 to output the content display information to the terminal 3.

The third communication processing unit 116 acquires the output request and the information related to the extraction condition(s) (ACT 31). In ACT 31, the third communication processing unit 116 acquires the output request and an extraction condition from the terminal 3 via the communication interface 14.

The third data processing unit 117 determines a type of the content that has been selected by the user based on the information provided related to the extraction condition(s) (ACT 32). In ACT 32, the third data processing unit 117 determines whether the content selected by the user is first type content or second type content.

If the content selected by the user is the first type content (ACT 32, YES), the processing transitions from ACT 32 to ACT 33. If the content selected by the user is the second type content (ACT 32, NO), the processing transitions from ACT 32 to ACT 35.

The third data processing unit 117 executes first generation processing (ACT 33). The first generation processing is processing for generating the display information based on the plurality of pieces of second POS data meeting the extraction condition(s). The third data processing unit 117 generates, using the first generation processing, the display information for the particular first type content selected by the user from the available content type options. In ACT 33, the third data processing unit 117 searches the POS data storage area 132 for the plurality of pieces of second POS data satisfying the first extraction condition indicated by the input information of the output request. The pieces of second POS data are data entries stored in the POS data storage area 132. The pieces of second POS data can be pieces of data collected from one or more POS devices 2. The pieces of second POS data can be data related to a plurality of transaction commodities. The pieces of second POS data can be pieces of data for a specific retailer or stores in the same organization. The plurality of transaction commodities related to pieces of second POS data can be sales commodities for the same retailer.

The third data processing unit 117 generates display information based on the pieces of second POS data satisfying the first extraction condition. For example, the third data processing unit 117 generates the first processing data based on aggregation of the pieces of second POS data satisfying the first extraction condition. The first processing data includes the first transaction performance data. The third data processing unit 117 can obtain the first transaction performance data based on the aggregation of pieces of second POS data. The third data processing unit 117 generates the display information for the first type content based on the first processing data.

Here, the first transaction performance data included in the first processing data differs according to the first type content. The first processing data can include the first transaction performance data on a per processing unit basis. In this context, a processing unit is a collection set for obtaining first transaction performance data as an aggregation or comparison across transactions. The processing unit may be one category or two or more categories or other entities or groupings. Hereinafter, several examples of a processing unit will be described, but processing units are not limited thereto.

The first processing data can include the first transaction performance data for at least one processing unit defined by the retailer. The processing unit can be a grouping or categories including a store of the retailer. The processing unit may be all comparable stores or all stores available. The processing unit may be a particular business grouping or classification. The processing unit may be defined by area or as a geographic grouping or the like. The processing unit may be defined as combinations of groupings, areas, classifications, or the like. The processing unit may be set according to the content type selected by the user or may otherwise be settable by the user.

The first processing data can include the first transaction performance data for at least one processing unit defined in relation to a transacted commodity or the like. For example, a processing unit encompass transactions involving a particular commodity, a grouping of commodities, a commodity attribute, a commodity type, or commodity classification. The processing unit may be defined based a collection or grouping of product sales and/or non-product sales (e.g., associated services). A processing unit defined by commodity related aspects may be combined with a processing unit defined by store related aspects.

The first processing data can include the first transaction performance data for at least one processing unit defined by a target time period. A time-based processing unit can be combined with other processing units.

The first processing data can include the first transaction performance data for a processing unit defined by deciles. In this context, a decile is a group of customers divided into 10 equal sub-groups in descending order of a purchase amount.

The third data processing unit 117 searches for, on a per processing unit basis, one or more pieces of second POS data included in the processing unit from among the plurality of pieces of second POS data satisfying the first extraction condition. For example, the third data processing unit 117 can search for one or more pieces of second POS data included in the processing unit based on various types of data such as the transaction date, the transaction time point, the store code, and the commodity code. The third data processing unit 117 can obtain, on a per processing unit basis, the first transaction performance based on one or more pieces of second POS data included in the processing unit.

Accordingly, the server 1 can generate the first processing data for first type content based on the aggregation required for the particular first type content. Therefore, the server 1 can provide a platform that enables outputting of information corresponding to various first type content.

The display information for the first type content is information generated based on the first processing data. The display information for the first type content is information for displaying the first type content on the terminal 3. The display of the first type content includes a display based on the first transaction performance in the first type content. The display based on the first transaction performance is a display using the first transaction performance.

The display based on the first transaction performance includes a display indicating the first transaction performance according to a display format of the first type content. The display indicating the first transaction performance includes a display indicating a value of the first transaction performance. The display indicating the first transaction performance includes not only the display indicating the value of the first transaction performance from the viewpoint of the transaction, but also the display indicating a value of the first transaction performance from the viewpoint of purchase by the customer or sales by the store. For example, if the first transaction performance includes the transaction price, a display indicating the transaction price includes a display indicating a value of the transaction price as a purchase price or a sales price.

The display based on the first transaction performance information may include a display indicating a value obtained by correcting the first transaction performance information. For example, correction is rounding, but is not limited thereto. The correction may be calculation for changing the value of the first transaction performance information. The display based on the first transaction performance information includes a display indicating a value obtained by correcting the first transaction performance according to the display format of the first type content. The display indicating the value obtained by correcting the first transaction performance information includes not only the display indicating a value obtained by correcting the first transaction performance information on a single transaction basis, but also a display indicating a value obtained by correcting the first transaction performance information on an overall purchase or sales basis.

The display of the first type content can include a display based on the first transaction performance for at least one processing unit defined by the target range of the retailer at least. The display of the first type content can include a display based on the first transaction performance for at least one processing unit defined by the target range of the commodity at least. The display of the first type content can include a display based on the first transaction performance for at least one processing unit defined by the target period at least. The display of the first type content can include a display based on the first transaction performance for a processing unit defined by deciles at least.

The display of the first type content can include a display of information for identifying the processing unit. For example, if the processing unit is defined by commodity, the information identifying the processing unit can be the name of the commodity or the like. The display of the first type content may include other kinds of information.

The third communication processing unit 116 outputs the display information generated by the third data processing unit 117 (ACT 34). In ACT 34, the third communication processing unit 116 outputs the display information to the terminal 3 of the user of the retailer via the communication interface 14. The terminal 3 displays an image of the first type content based on the display information.

The third data processing unit 117 executes second generation processing (ACT 35). The second generation processing is processing for generating the display information based on the plurality of pieces of second POS data and the plurality of pieces of receipt data. The third data processing unit 117 generates, using the second generation processing, the display information for one second type content selected by the user.

In ACT 35, the third data processing unit 117 searches the POS data storage area 132 for the plurality of pieces of second POS data satisfying the second extraction condition indicated by the input information. The pieces of second POS data are stored in the POS data storage area 132. The pieces of second POS data are pieces of data collected from one or more POS devices 2. The pieces of second POS data can be related to a plurality of transaction commodities. The pieces of second POS data can be from a specific retailer. If the specific retailer operates a single store, the plurality of pieces of second POS data are from the same store.

The third data processing unit 117 searches the receipt data storage area 133 for the plurality of pieces of receipt data satisfying the second extraction condition indicated by the input information. The plurality of pieces of second receipt data are pieces of data stored in the receipt data storage area 133. The plurality of pieces of receipt data are pieces of data for one or more receipts. The plurality of pieces of receipt data are pieces of data related to a plurality of transaction commodities. The plurality of pieces of receipt data are pieces of data related to a plurality of retailers. In this case, the plurality of transaction commodities related to the plurality of pieces of receipt data are sales commodities in the plurality of retailers. The plurality of retailers may or may not include the specific retailer.

The third data processing unit 117 generates the display information based on the plurality of pieces of POS data and the plurality of pieces of receipt data satisfying the second extraction condition. An example of the second generation processing will be described later.

As described above, the server 1 can generate the display information for one second type content selected from a plurality of second type content by the user.

Accordingly, the server 1 can allow the user to view an image of one second type content selected by the user on a platform on which images corresponding to various second type content can be viewed. The user does not need to use a different platform for each second type content, and thus user convenience is improved.

As described above, the server 1 can generate the display information based on the plurality of pieces of second POS data of the specific retailer and the receipt data of the plurality of retailers.

Accordingly, the server 1 can allow the user to view an image in which the specific retailer performance can be compared with other available performance data, such as aggregated public sales data.

The third communication processing unit 116 outputs the display information generated by the third data processing unit 117 (ACT 36). In ACT 36, the third communication processing unit 116 outputs the display information to the terminal 3 of the user of the retailer via the communication interface 14. The terminal 3 displays an image of the second type content based on the display information.

As described above, the server 1 can output the display information to the terminal 3 of the user of the retailer.

Accordingly, the server 1 can output, to the terminal 3 of the user of the specific retailer, the information corresponding to the first type content based on the plurality of pieces of second POS data of the specific retailer. The server 1 can output, to the terminal 3 of the user of the specific retailer, the information corresponding to the second type content based on the plurality of pieces of second POS data and the plurality of pieces of receipt data of the specific retailer.

The retailer can easily acquire information corresponding to various content serving as analysis solutions by accessing the server 1, thereby improving convenience.

As described above, the server 1 can store the second POS data in the POS data storage area 132 based on the first POS data. The server 1 can output information based on a plurality of pieces of second POS data.

Accordingly, the server 1 can provide a platform that manages the POS data in a unified format and outputs information corresponding to various content based on POS data in a unified format. By providing such a platform, the server 1 can support distribution of the POS data, such as collection of POS data and output of information based on the POS data.

Since the retailer does not need to separately provide data to each data service operator in a format for each data service operator, a workload of the retailer is reduced. The retailer can easily acquire the information corresponding to various content serving as analysis solutions.

Here, the user of the retailer is described as an example, and the same applies to a user of another vendor. In this case, in the description with reference to FIG. 7, the notation “user of retailer” may be replaced as “user of another vendor”. The plurality of pieces of second POS data used for generating the display information are pieces of data in which the use authority is set to another vendor. Therefore, the plurality of pieces of second POS data are pieces of data for a specific retailer different from another vendor. The plurality of pieces of second POS data may be data for the same retailer. The plurality of pieces of second POS data may be data set for two or more retailers, depending on the number of use authority set for another vendor.

As described above, the server 1 can output, to the terminal 3 of the user of another vendor, the information corresponding to the first type content based on the plurality of pieces of second POS data for which the use authority is set. The server 1 can output, to the terminal 3 of the user from another vendor, the information corresponding to the second type content based on the plurality of pieces of second POS data and the plurality of receipt data for which the use authority is set.

Accordingly, the server 1 can similarly provide the information to another vendor to whom use authority has been given via the same platform that provides the information to the retailer.

The other vendor can easily acquire information corresponding to various content by accessing the server 1, thereby improving convenience.

The second generation processing performed by the processing circuit 11 of the server 1 will be described.

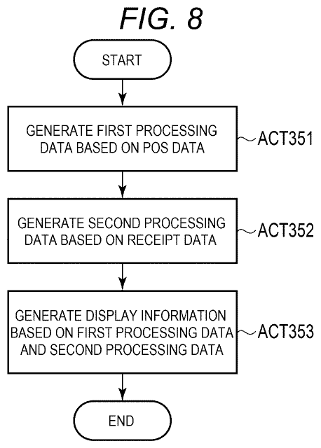

FIG. 8 is a flowchart showing an example of the second generation processing performed by the processing circuit 11 of the server 1.

The third data processing unit 117 generates the first processing data based on the plurality of pieces of second POS data satisfying the second extraction condition (ACT 351). In ACT 351, the third data processing unit 117 generates the first processing data based on the aggregation of the pieces of second POS data satisfying the second extraction condition. The first processing data includes the first transaction performance information. The third data processing unit 117 can obtain the first transaction performance information based on the aggregation of the pieces of second POS data.

Here, the first transaction performance information to be included in the first processing data differs according to the second type content. The first processing data can include the first transaction performance information on a per processing unit basis. The processing units for the first transaction performance information for the second type content can be the same as the processing units for the first transaction performance for the first type content described in ACT 33.

The third data processing unit 117 searches for, on a per processing unit basis, one or more pieces of second POS data included in the processing unit from among the plurality of pieces of second POS data satisfying the second extraction condition. The third data processing unit 117 can obtain, on a per processing unit basis, the first transaction performance based on one or more pieces of second POS data included in the processing unit.

The third data processing unit 117 generates the second processing data based on the plurality of pieces of receipt data satisfying the second extraction condition (ACT 352). In ACT 352, the third data processing unit 117 generates the second processing data based on the aggregation of the plurality of pieces of receipt data satisfying the second extraction condition. The second processing data includes the second transaction performance information. The third data processing unit 117 can obtain the second transaction performance information based on the aggregation of the plurality of pieces of receipt data.

Here, the second transaction performance information included in the second processing data may differ according to the second type content. The second processing data can include the second transaction performance information on a per processing unit basis. In this context, a processing unit is a collection of attributes or a grouping for which the second transaction performance information is acquired. The processing unit may be considered a filter setting or the like for selecting specific data for analysis (processing). A processing unit may be defined by one item or two or more items. Hereinafter, several examples of a processing unit will be described, but the processing units are not limited thereto.

The second processing data can include the second transaction performance information for a processing unit defined by a comparison range. A processing unit defined by a comparison range can be a collection items or attributes to be compared to each other. The processing unit may be a collection of business categories included in the comparison range. The processing unit may be a collection of areas to be compared. The processing unit may be a combinations of business categories and areas. The processing unit may encompass each store to be compared. The comparison range may be determined according to the second type content or may be settable by the user.

The second processing data can include the second transaction performance information for a processing unit defined based on a commodity characteristic, attribute, type, or the like. The processing unit may be defined as a collection of different commodities, products, or services (non-product sales). The processing unit nay be set according to the selected second type content or may be settable by the user.

The second processing data can include the second transaction performance information for a processing unit defined by a time period, a grouping of time periods, or the like. For example, the time period may be one month, one week, or any arbitrary period. The processing unit may be defined according to the second type content or may be settable by the user.

The second processing data can include the second transaction performance information for a processing unit defined as deciles.

The third data processing unit 117 searches for, on a per processing unit basis, second POS data included in (matching) the processing unit from among the second POS data satisfying the second extraction condition. The third data processing unit 117 can obtain, on a per processing unit basis, the second transaction performance information based on second POS data included in the processing unit.

The third data processing unit 117 generates the display information for the second type content based on the first processing data and the second processing data (ACT 353).

As described above, the server 1 can generate the first processing data based on the aggregation of the plurality of pieces of second POS data. The server 1 can generate the second processing data based on the aggregation of the plurality of pieces of receipt data.

Accordingly, the server 1 can generate the first processing data for each of the second type content based on the aggregation required for each of the second type content. The server 1 can generate the second processing data for each of the second type content based on the aggregation required for each of the second type content. Therefore, the server 1 can provide a platform that enables viewing of images corresponding to various second type content.

The display information for the second type content will be described.

The display information for the second type content is information generated based on the first processing data and the second processing data. The display information for the second type content is information for displaying the second type content on the terminal 3.

In a first example, the display information for the second type content is information for a display based on comparison between the first processing data and the second processing data. Hereinafter, a result obtained by a comparison between the first processing data and the second processing data is also referred to as a comparison of processing data. For example, the comparison of the processing data provides the value of a difference between the first processing data and the second processing data. The comparison of the processing data includes a display based on a comparison between the first and second transaction performance information. Hereinafter, a result obtained by a comparison between the first and second transaction performance information is also referred to as a comparison of transaction performance. For example, the comparison of transaction performance can be a difference between the first transaction performance information and the second transaction performance information.

The display in the first example includes the display based on the comparison of the processing data. A display based on the comparison of the processing data can be the same as the display based on the first transaction performance information for the first type content described above. As such, in the above description of a display based on the first transaction performance information for the first type content, “first transaction performance” may be replaced with “comparison of the processing data”. The notation of the “first type content” may be replaced as a “first example of the second type content”.

By viewing a display based on the comparison of the processing data, the user can easily see the comparison between the first transaction performance of the specific retailer and the second transaction performance of the public.

By viewing a display based on the difference between the first transaction performance and the second transaction performance, the user can easily grasp, for individual items such as the price of the commodity, the difference between the first transaction performance of the specific retailer and the second transaction performance of the public. The user can consider appropriateness of aspects of the first transaction performance information for the specific retailer related to different items of interest.

The display in the first example may include a display based on a calculation result using the comparison of the processing data. A display example of the display based on the calculation result using the comparison result of the processing data is substantially the same as the display example of the display based on the first transaction performance in the first type content as described above. In this case, in the description of the display based on the first transaction performance in the first type content as described above, the notation of the “first transaction performance” may be replaced as the “calculation result using the comparison result of the processing data”. The notation of the “first type content” may be replaced as a “first example of the second type content”.

By viewing the display based on the calculation result using the comparison of the processing data, the user can easily grasp the information useful for the operation of the store without having to perform the calculation using the comparison of the processing data by himself or herself.

The display in the first example can include a display based on the first transaction performance. A display example of the display based on the first transaction performance is the same as a display example of the display based on the first transaction performance in the first type content as described above. In this case, in the description of the display based on the first transaction performance in the first type content as described above, the notation of the “first type content” may be replaced as the “first example of the second type content”.

By viewing the display based on the first transaction performance, the user can check the first transaction performance information together with the comparison of the processing data. Accordingly, the user can appropriately grasp a transaction status at the specific retailer for the items related to the first transaction performance, such as the price of the commodity.

The display in the first example can include a display based on the second transaction performance. A display example of the display based on the second transaction performance is the same as the display example of the display based on the first transaction performance in the first type content as described above. In this case, in the description of the display based on the first transaction performance in the first type content as described above, the notation of the “first transaction performance” may be replaced as the “second transaction performance”. The notation of the “first type content” may be replaced as the “first example of the second type content”.

By viewing the display based on the second transaction performance, the user can check the second transaction performance together with the comparison result of the processing data. Accordingly, the user can appropriately grasp a transaction status in the public with respect to the items related to the second transaction performance, such as the price of the commodity related to the comparison result of the processing data.

The display in the first example can include a display of information for identifying the processing unit. The display in the first example may include other kinds of information.

In a second example, the display information for the second type content is information for a display based on the first transaction performance and the second transaction performance. The display based on the first transaction performance and the second transaction performance is a display using the first transaction performance and the second transaction performance.

The display in the second example can include a display based on the first transaction performance. For example, the display in the second example can include a display based on the first transaction performance in the entire target period. The display in the second example can include a display based on the first transaction performance for each predetermined period in the target period. A display example of the display based on the first transaction performance is the same as the display example of the display based on the first transaction performance in the first type content as described above. In this case, in the description of the display based on the first transaction performance in the first type content as described above, the notation of the “first type content” may be replaced as a “second example of the second type content”.

The display in the second example can include a display based on the second transaction performance. For example, the display in the second example can include a display based on the second transaction performance in the entire target period. The display in the second example can include a display based on the second transaction performance for each predetermined period in the target period. A display example of the display based on the second transaction performance is the same as the display example of the display based on the first transaction performance in the first type content as described above. In this case, in the description of the display based on the first transaction performance in the first type content as described above, the notation of the “first transaction performance” may be replaced as the “second transaction performance”. The notation of the “first type content” may be replaced as the “second example of the second type content”.

By viewing the display based on the first transaction performance and the display based on the second transaction performance, the user can compare the first transaction performance with the second transaction performance. By comparing the first transaction performance with the second transaction performance, the user can grasp the transaction status at the specific retailer while comparing the transaction status with the transaction status in the public.

By viewing the display based on the first transaction performance for each predetermined period and the display based on the second transaction performance for each predetermined period, the user can compare a transition of the first transaction performance with a transition of the second transaction performance. By comparing the transition of the first transaction performance with the transition of the second transaction performance, the user can see the trend in transactions at the specific retailer while comparing the trend to public data.

The display based on the first transaction performance and the display based on the second transaction performance may be included in one display area or may be included in different display areas. In a case in which the displays are included in one display area, the display based on the first transaction performance and the display based on the second transaction performance may be in the same graph or table, or may be in different graphs or tables.

The display in the second example can include a display of information for identifying the processing unit. The display in the second example may include other kinds of information.

In a third example, the display information for the second type content is information for a display of commodities not included in the first processing data in the second processing data. Hereinafter, a commodity not included in the first processing data in the second processing data is also referred to as a target commodity. The target commodity is a commodity that is not transacted at the specific retailer but is transacted elsewhere. Therefore, the target commodity may be a commodity that is handled by a specific retailer or not. If there are one or more target commodities, a display of each target commodity may be shown. If a target commodity is not present, a display that the target commodity is not present may be shown.

The display in the third example includes a display of information for identifying a target commodity. For example, the information identifying the target commodity can be a name or a commodity code.

By viewing the display of the information for identifying the target commodity, the user can more easily grasp which commodity particular is the target commodity.

The display in the third example can include a display based on the second transaction performance of the target commodity. A display example of the display based on the second transaction performance is the same as the display example of the display based on the first transaction performance in the first type content as described above. In this case, in the description of the display based on the first transaction performance in the first type content as described above, the notation of the “first transaction performance” may be replaced as the “second transaction performance”. The notation of the “first type content” may be replaced as a “third example of the second type content”.

By viewing the display based on the second transaction performance of the target commodity, the user can easily grasp how the target commodity is sold in the public with respect to the items such as the price of the commodity.

The display in the third example can include a display of information for identifying the processing unit. The display in the third example can include a display of a category of the target commodity. The display in the third example can include a display of a manufacturer of the target commodity. The display in the third example may include other kinds of information.

An example of the first type content will be described.

For example, the first type content includes “sales”, “customer analysis”, and a “recommendation”. Here, “sales” is content that allows grasping of sales at a specific retailer. The sales can be a sales amount obtained by the specific retailer through transactions. The “customer analysis” is content that allows grasping of a customer purchase trend at a specific retailer. The “recommendation” is content that suggests improvement points for a specific retailer. The “sales” content may include a “prompt sales report” and “sales aggregation”. The “customer analysis” may include a “decile analysis”, an “ABCD analysis”, and a “brand switch”. The “recommendation” may include “dynamic pricing” and/or “commodity alignment”. The first type content is not limited thereto. The first type content can be appropriately set. The first transaction performance data described below is an example and can be appropriately set.

The content of a “prompt sales report” will be described.

The content of “prompt sales report” is related to the sales at time points of aggregation processing which is performed a plurality of times over an operation period, for example a regular operating day.

In the example, the first transaction performance can include first transaction performance (A). The first transaction performance (A) is an aggregation value at predetermined times during an operating day (regular business day). The first transaction performance (A) corresponds to the cumulative sales up to the time points of the aggregation processing at the store. The first processing data includes the first transaction performance (A) on a per processing unit basis. The third data processing unit 117 can obtain the first transaction performance (A) based on the transaction amounts included in the second POS data.

For example, the first processing data can be the first transaction performance (A) for all stores collectively. The first processing data can be the first transaction performance (A) for each area. The first processing data may be the first transaction performance (A) for combinations of business category and area. The first processing data can include the first transaction performance (A) for product sales. The first processing data can include the first transaction performance (A) for non-product sales. The first processing data can include the first transaction performance (A) for different commodity types.

A display of the “prompt sales report” includes a display based on the first transaction performance (A). The display of the “prompt sales report” is not limited to the above-described example.

The retailer can use the “prompt sales report”, to see the sales at different time points of the aggregation for a collection of stores or a collection of commodities.

The content of a “sales aggregation” will be described.

The content of a “sales aggregation” is related to sales aggregation over some grouping or time period. For example, the sales aggregation can be an amount obtained by aggregating sales over two days or more.

In the example, the first transaction performance data can include first transaction performance (B). The first transaction performance (B) is an aggregation value obtained by summing up the transaction amounts for a period of two days or more. The first transaction performance (B) corresponds to the sales aggregation from the viewpoint of sales by the store. The first processing data includes the first transaction performance (B) on a per processing unit basis. The third data processing unit 117 can obtain the first transaction performance (B) based on the transaction amount included in the second POS data.

The first transaction performance data can include first transaction performance (C). The first transaction performance (C) can be a statistical value obtained by dividing the first transaction performance (B) of a current year by the first transaction performance (B) of the previous year. Here, the statistical value is a ratio. The first transaction performance (C) corresponds to a previous year ratio of the sales aggregation from the viewpoint of sales by the store. The first processing data includes the first transaction performance (C) on a per processing unit basis. The third data processing unit 117 can obtain the first transaction performance (C) based on the transaction amount included in the second POS data.

For example, the first processing data can include all or a part of the first transaction performance (B) and the first transaction performance (C) for all stores collectively. The first processing data can include all or a part of the first transaction performance (B) and the first transaction performance (C) for each area. The first processing data can include all or a part of the first transaction performance (B) and the first transaction performance (C) for each commodity type. The first processing data can include all or a part of the first transaction performance (B) and the first transaction performance (C) in the entire target period. The first processing data can include all or a part of the first transaction performance (B) and the first transaction performance (C) for each predetermined period in the target period.

A display for the content of a “sales aggregation” includes a display based on the first transaction performance (B) in relation to the sales aggregation. The display for the content of “sales aggregation” includes a display based on the first transaction performance (C) in relation to the previous year ratio of the sales aggregation. The display of a “sales aggregation” is not limited to the above-described example. The first transaction performance may include a value different from the first transaction performance (B) and the first transaction performance (C).

The retailer can grasp, using the content of “sales aggregation”, a change in the sales aggregation values for a collection of stores or a collection of commodities.

The content of a “decile analysis” will be described.

The content of a “decile analysis” is related to purchase performance for each decile. The purchase performance is performance of a purchase of commodities made by a customer. For example, the purchase performance includes all or a part of a total purchase amount, a purchase amount ratio, and a purchase amount per person, but is not limited thereto. The total purchase amount is an amount obtained by summing up the purchase amounts of customers. The purchase amount ratio is a ratio of the total purchase amounts of one decile to the total purchase amounts of all deciles. The purchase amount per person is an average value of the purchase amounts of customers included in one decile.

In the example, the first transaction performance can include first transaction performance (D). The first transaction performance (D) is an aggregation value obtained by summing up the transaction amounts for each decile. The first transaction performance (D) corresponds to the total purchase amount from the viewpoint of purchase by the customer. The first processing data includes the first transaction performance (D) for each decile. The third data processing unit 117 can obtain the first transaction performance (D) based on the transaction amount included in the second POS data.

The first transaction performance can include first transaction performance (E). The first transaction performance (E) can include a statistical value obtained by dividing a value obtained by summing up the first transaction performance (D) of all the deciles by the first transaction performance (D) of one decile. The statistical value is a ratio. The first transaction performance (E) corresponds to the purchase amount ratio from the viewpoint of purchase by the customer. The first processing data includes the first transaction performance (E) on a per processing unit basis. The third data processing unit 117 can obtain the first transaction performance (E) based on the transaction amount included in the second POS data.

The first transaction performance can include first transaction performance (F). The first transaction performance (F) is a statistical value obtained by dividing the first transaction performance (D) by the number of customers included in one decile. The first transaction performance (F) corresponds to the purchase amount per person from the viewpoint of purchase by the customer. The first processing data includes the first transaction performance (F) on a per processing unit basis. The third data processing unit 117 can obtain the first transaction performance (F) based on the transaction amount included in the second POS data.

For example, the first processing data can include all or a part of the first transaction performance (D), the first transaction performance (E), and the first transaction performance (F) for each decile for all stores collectively. The first processing data can include all or a part of the first transaction performance (D), the first transaction performance (E), and the first transaction performance (F) for each decile for all commodities collectively. The first processing data can include all or a part of the first transaction performance (D), the first transaction performance (E), and the first transaction performance (F) for each decile in the entire target period.

A display for the content of “decile analysis” includes a display based on the first transaction performance (D) in relation to the total purchase amount. The display for the “decile analysis” includes a display based on the first transaction performance (E) in relation to the purchase amount ratio. The display for the content of “decile analysis” includes a display based on the first transaction performance (F) in relation to the purchase amount per person. The display of the “decile analysis” is not limited to the above-described example. The first transaction performance may include a value different from the first transaction performance (D), the first transaction performance (E), and the first transaction performance (F).

The retailer can see the purchase trend for each decile using the content of “decile analysis”.

The content of an “ABCD analysis” will be described.

The content of an “ABCD analysis” is a related to sales performance related to an individual commodity. The sales performance information can be performance of sales of commodities by store. For example, the sales performance information includes all or a part of sales, a sales quantity, and a sales amount ratio for each decile, but is not limited thereto. The sales quantity is the number of a particular commodity sold by the store. The sales amount ratio is a ratio of the total purchase amount of one decile to the overall sales.

In the example, the first transaction performance can include first transaction performance (G). The first transaction performance (G) is an aggregation value obtained by summing up the transaction amounts on a per commodity item basis. The first transaction performance (G) corresponds to sales of each commodity from the viewpoint of sales by the store. The first processing data includes the first transaction performance (G) on a per processing unit basis. The third data processing unit 117 can obtain the first transaction performance (G) based on the transaction amount included in the second POS data.

The first transaction performance can include first transaction performance (H). The first transaction performance (H) is an aggregation value obtained by summing up the transaction quantities on a per commodity item basis. The first transaction performance (H) corresponds to the sales quantity for each commodity from the viewpoint of sales by the store. The first processing data includes the first transaction performance (H) on a per processing unit basis. The third data processing unit 117 can obtain the first transaction performance (H) based on the transaction quantity included in the second POS data.

The first transaction performance can include first transaction performance (I). The first transaction performance (I) is an aggregation value obtained by summing up the transaction amounts for each decile for one commodity. The first transaction performance (I) corresponds to the total purchase amount for each decile from the viewpoint of purchase by the customer. The first processing data includes the first transaction performance (I) on a per processing unit basis. The third data processing unit 117 can obtain the first transaction performance (I) based on the transaction amount included in the second POS data.

The first transaction performance can include first transaction performance (J). The first transaction performance (J) includes a statistical value obtained by dividing the first transaction performance (G) for each commodity by the first transaction performance (I) for each decile. The statistical value is a ratio. The first transaction performance (J) corresponds to the sales amount ratio for each decile of each commodity from the viewpoint of sales by the store. The first processing data includes the first transaction performance (J) on a per processing unit basis. The third data processing unit 117 can obtain the first transaction performance (J) based on the transaction amount included in the second POS data.

For example, the first processing data can include all or a part of the first transaction performance (G), the first transaction performance (H), the first transaction performance (I), and the first transaction performance (J) for each commodity for all stores collectively. The first processing data can include all or a part of the first transaction performance (G), the first transaction performance (H), the first transaction performance (I), and the first transaction performance (J) for each commodity in the entire target period.

A display of the “ABCD analysis” includes a display based on the first transaction performance (G) in relation to the sales of each commodity. The display of the “ABCD analysis” includes a display based on the first transaction performance (H) in relation to the sales quantity of each commodity. The display of the “ABCD analysis” includes a display based on the first transaction performance (J) in relation to the sales amount ratio for each decile for each commodity. The display of the “ABCD analysis” is not limited to the above-described example. The first transaction performance may include a value different from the first transaction performance (G), the first transaction performance (H), the first transaction performance (I), and the first transaction performance (J).

The retailer can see the purchase trend of each commodity by decile using the content of “ABCD analysis”. For example, the retailer can easily identify a commodity that is often purchased by a customer in decile having a large purchase amount but may have low sales as a whole.

The content of a “brand switch” analysis will be described.

The “brand switch” analysis is related to sales performance for each commodity during each predetermined period (interval) in a target time period. For example, the sales performance includes all or part of the sales quantity and sales, but is not limited thereto.

In the example, the first transaction performance can include first transaction performance (K). The first transaction performance (K) is an aggregation value obtained by summing up the transaction quantities for each commodity for each predetermined period in the target period. The first transaction performance (K) corresponds to the sales quantity of each commodity for each predetermined period in the target period from the viewpoint of sales by the store. The first processing data includes the first transaction performance (K) on a per processing unit basis. The third data processing unit 117 can obtain the first transaction performance (K) based on the transaction quantity included in the second POS data.

The first transaction performance can include first transaction performance (L). The first transaction performance (L) is an aggregation value obtained by summing up the transaction amounts for each commodity for each predetermined period in the target period. The first transaction performance (L) corresponds to the sales of each commodity for each predetermined period in the target period from the viewpoint of sales by the store. The first processing data includes the first transaction performance (L) on a per processing unit basis. The third data processing unit 117 can obtain the first transaction performance (L) based on the transaction amount included in the second POS data.

For example, the first processing data can include all or a part of the first transaction performance (K) and the first transaction performance (L) for each commodity for each predetermined d period in the target period for all stores collectively.

A display on the content of “brand switch” includes a display based on the first transaction performance (K) in relation to the sales quantity for each commodity for each predetermined period in the target period. The display of the content of a “brand switch” includes a display based on the first transaction performance (K) in relation to the sales for each commodity for each predetermined period in the target period. The display of a “brand switch” analysis is not limited to the above-described example. The first transaction performance may include a value different from the first transaction performance (K) and the first transaction performance (L).

The retailer can grasp changes in a customer purchase trend for a commodity over time using the “brand switch” analysis. For example, the retailer can clarify the brand switching checking the purchase trends for a plurality of similar commodities or substitutes. Accordingly, the retailer can find a beneficial bargain-priced commodity.

The content of “dynamic pricing” analysis will be described.

The “dynamic pricing” analysis is related to sales performance for a specific commodity during each time zone (increment or part of a day, time period, or the like). For example, the sales performance includes all or a part of the sales quantity, an average sales price, the sales, and the number of customers, but is not limited thereto. The average sales price is an average value of sales prices of a specific commodity. The number of customers is the number of customers who visit the store regardless of whether the specific commodity is purchased. The specific commodity can be a commodity whose sales price varies according to time of day or the like. For example, the specific commodity is a commodity such as a prepared dish, fish, or meat, but is not limited thereto. For example, the time zone for analysis is every hour after preparation, but is not limited thereto.

In the example, the first transaction performance can include first transaction performance (M). The first transaction performance (M) is an aggregation value obtained by summing up the transaction quantities for the specific commodity for each time zone. The first transaction performance (M) corresponds to the sales quantity for the specific commodity for each time zone by store. The first processing data includes the first transaction performance (M) on a per processing unit basis. The third data processing unit 117 can obtain the first transaction performance (M) based on the transaction quantity included in the second POS data.

The first transaction performance can include first transaction performance (N). The first transaction performance (N) is a statistical value obtained by averaging the transaction prices for the specific commodity for each time zone. The statistical value is an average value. The first transaction performance (N) corresponds to the average sales price for the specific commodity for each time zone from the viewpoint of sales by the store. The first processing data includes the first transaction performance (N) on a per processing unit basis. The third data processing unit 117 can obtain the first transaction performance (N) based on the transaction price included in the second POS data.

The first transaction performance can include first transaction performance (O). The first transaction performance (O) is an aggregation value obtained by summing up the transaction amounts for the specific commodity for each time zone. The first transaction performance (O) corresponds to the sales for the specific commodity for each time zone from the viewpoint of sales by the store. The first processing data includes the first transaction performance (O) on a per processing unit basis. The third data processing unit 117 can obtain the first transaction performance (O) based on the transaction amount included in the second POS data.

The first transaction performance can include first transaction performance (P). The first transaction performance (P) is an aggregation value obtained by uniquely counting the member numbers for the specific commodity for each time zone. The first transaction performance (P) corresponds to the number of customers for the specific commodity for each time zone from the viewpoint of sales by the store. The first processing data includes the first transaction performance (P) on a per processing unit basis. The third data processing unit 117 can obtain the first transaction performance (P) based on the member number included in the second POS data.

For example, the first processing data can include all or a part of the first transaction performance (M), the first transaction performance (N), the first transaction performance (O), and the first transaction performance (P) for the specific commodity for each time zone for each store.

A display related to the content of “dynamic pricing” includes a display based on the first transaction performance (M) in relation to the sales quantity for the specific commodity for each time zone. A display related to the content of “dynamic pricing” includes a display based on the first transaction performance (N) in relation to the average sales price for the specific commodity for each time zone. The display related to the content of “dynamic pricing” includes a display based on the first transaction performance (O) in relation to the sales for the specific commodity for each time zone. The display related to the content of “dynamic pricing” includes a display based on the first transaction performance (P) in relation to the sales quantity of the specific commodity in each time zone and in relation to the number of customers for the specific commodity in each time zone. The display of the “dynamic pricing” analysis is not limited to the above-described example. The first transaction performance may include a value different from the first transaction performance (M), the first transaction performance (N), the first transaction performance (O), and the first transaction performance (P).

The retailer can judge the appropriateness of a sales price for the specific commodity within each time zone using the content of “dynamic pricing” analysis.

The content of a “commodity alignment” will be described.

The content of “commodity alignment” is related to the sales performance for a commodity. For example, the sales performance includes all or a part of a total sales quantity and sales prices in each store, but is not limited thereto. The total sales quantity is obtained by summing up the sales quantities of one commodity sold from each store. The sales price is a price at which one commodity is sold at a store.

In the example, the first transaction performance can include first transaction performance (Q). The first transaction performance (Q) is an aggregation value obtained by summing up the transaction quantities for each commodity. The first transaction performance (Q) corresponds to the total sales quantity from the viewpoint of sales by the store. The first processing data includes the first transaction performance (Q) on a per processing unit basis. The third data processing unit 117 can obtain the first transaction performance (Q) based on the transaction quantity included in the second POS data.

The first transaction performance can include first transaction performance (R). The first transaction performance (R) is a statistical value obtained by averaging the transaction prices for each commodity and each store. The statistical value is an average value. The first transaction performance (R) corresponds to the sales prices in each store from the viewpoint of sales by the store. The first processing data includes the first transaction performance (R) on a per processing unit basis. The third data processing unit 117 can obtain the first transaction performance (R) based on the transaction price included in the second POS data.

For example, the first processing data can include all or a part of the first transaction performance (Q) and the first transaction performance (R) in the entire target period.

A display related to the content t of “commodity alignment” includes a display based on the first transaction performance (Q) in relation to the total sales quantity of each commodity. The display related to the content of “commodity alignment” includes a display based on the first transaction performance (R) in relation to the sales price of each commodity in each store. The display of the “commodity alignment” content is not limited to the above-described example. The first transaction performance may include a value different from the first transaction performance (Q) and the first transaction performance (R).

The retailer can compare the purchase trend of each commodity between stores using the content of “commodity alignment”. For example, by comparing the sales prices between stores, the retailer can judge whether the returning of the sales price is forgotten.

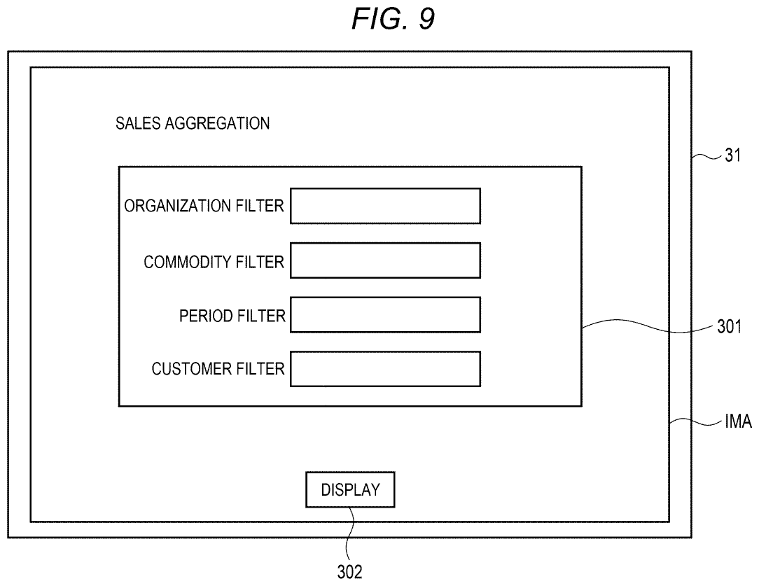

FIG. 9 is a diagram showing an example of an image for inputting the first extraction condition for the first type content displayed on a display device 31 of the terminal 3.

The display device 31 is a liquid crystal display or an organic electroluminescence (EL) display, but is not limited thereto.

The display device 31 displays an image IMA for inputting the first extraction condition for the first type content. Here, the first type content is “sales aggregation” information. The first extraction condition is a condition to be input for displaying particular “sales aggregation” information on the display device 31.

The image IMA includes an area 301 in which the first extraction condition can be input. The area 301 includes an area for “organization filter”, an area for “commodity filter”, an area for “period filter”, and an area for “customer filter”. The area for “organization filter” is an area in which conditions related to a store owned by a specific retailer can be input. The area for “commodity filter” is an area in which conditions related to a commodity can be input. The area for “period filter” is an area in which conditions related to a period can be input. The area for “customer filter” is an area in which conditions related to a customer attribute can be input.

The image IMA includes a “display” button 302 for an output instruction.

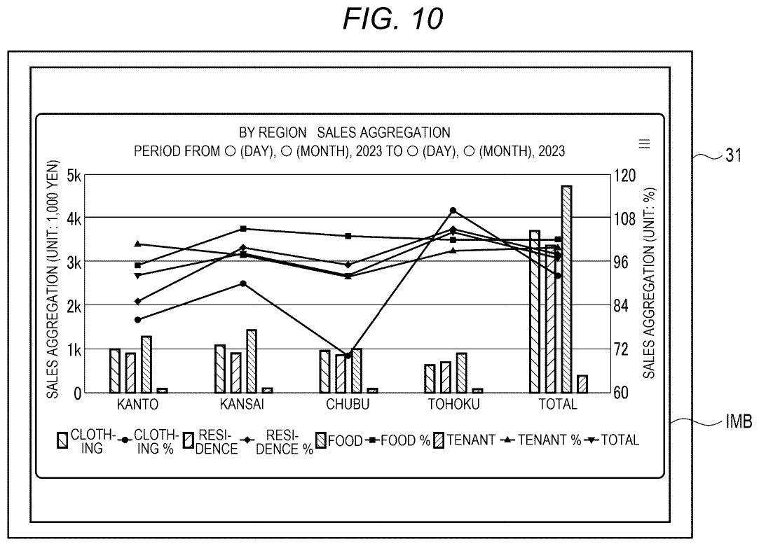

FIG. 10 is a diagram showing an example of an image of the first type content displayed on the display device 31 of the terminal 3.

The display device 31 displays the image IMB of the first type content based on the display information. It is assumed that the display information is generated by the server 1 based on the first extraction condition input in the image IMA shown in FIG. 9. Here, the first type content is the content of “sales aggregation”.

The image IMB displays the above-described first transaction performance (B) in a bar graph format as the sales aggregation for the content of “sales aggregation”. The display for the sales aggregation in the bar graph format is an example of the display based on the first transaction performance (B). The image IMB displays the above-described first transaction performance (C) in a line graph format as the previous year ratio of the sales aggregation for the content of “sales aggregation”. The display in the line graph format for the previous year ratio of the sales aggregation is an example of the display based on the first transaction performance (C). Here, values of the sales aggregation and the previous year ratio of the sales aggregation are values in the entire target period for each combination of the commodity type and the area.

A display example for the second type content will be described.

For example, the second type content includes a “first price check”, a “second price check”, and a “new commodity check”. The content of “first price check” and the “second price check” permit comparing of the first transaction performance data and the second transaction performance data on a per commodity item basis. A “new commodity check” permits the checking of the sales performance of a target commodity that is transacted elsewhere but is not yet transacted at the specific retailer. The second type content is not limited thereto. The second type content can be appropriately set.

The content of “first price check” will be described.

The content of “first price check” is the first example described above.

The content of “first price check” is related to a difference between the sales performance of a specific retailer for each commodity and the sales performance at a plurality of retailers. For example, the sales performance information is the sales price and the sales quantity.

In the example, the first transaction performance data can include first transaction performance (S1). The first transaction performance (S1) is a statistical value obtained by the transaction price for each commodity. For example, the statistical value is an average value obtained by averaging the transaction prices, and may be a highest value, a lowest value, a mode, a median, or the like of the transaction prices. The first transaction performance (S1) corresponds to the sales price at the specific retailer or store. For example, the sales price at the specific retailer is an average value, or may be a highest value, a lowest value, a mode, a median, or the like. The first processing data includes the first transaction performance (S1) on a per processing unit basis. The third data processing unit 117 can obtain the first transaction performance (S1) based on the transaction price included in the second POS data. The first transaction performance (S1) is an example of a first transaction price of a commodity in the first example.

The first transaction performance can include first transaction performance (T). The first transaction performance (T) is an aggregation value obtained by summing up the transaction quantities. The first transaction performance (T) corresponds to the sales quantity of commodities of a specific retailer by store. The sales quantity is a number obtained by summing up the sales quantities for each transaction for each commodity. The first processing data includes the first transaction performance (T) on a per processing unit basis. The third data processing unit 117 can obtain the first transaction performance (T) based on the transaction quantity included in the second POS data. The first transaction performance (T) is an example of the transaction quantity of commodities.

For example, the first processing data may include all or a part of the first transaction performance (S1) and the first transaction performance (T) for each commodity in the entire target period for all stores collectively. The first processing data may include all or a part of the first transaction performance (S1) and the first transaction performance (T) for each commodity in the entire target period in each area. The first processing data may include all or a part of the first transaction performance (S1) and the first transaction performance (T) for each commodity for each predetermined period in the target period for all stores collectively. The first processing data may include all or a part of the first transaction performance (S1) and the first transaction performance (T) for each commodity for each predetermined period in the target period in each area.

The second transaction performance can include second transaction performance (S2). The second transaction performance (S2) is a statistical value obtained by the transaction price for each commodity. For example, the statistical value is an average value obtained by averaging the transaction prices, and may be a highest value, a lowest value, a mode, a median, or the like of the transaction prices. The second transaction performance (S2) corresponds to the sales prices at a plurality of retailers or stores. For example, the sales price at a specific retailer can be an average value, or may be a highest value, a lowest value, a mode, a median, or the like. The second processing data includes the second transaction performance (S2) on a per processing unit basis. The third data processing unit 117 can obtain the second transaction performance (S2) based on the transaction prices included in the receipt data. The second transaction performance (S2) is an example of a second transaction price of a commodity in the first example.

For example, the second processing data may include the second transaction performance (S2) for each commodity in the entire target period for all stores collectively. The second processing data may include the second transaction performance (S2) for each commodity in the entire target period in each area. The second processing data may include the second transaction performance (S2) for each commodity for each predetermined period in the target period for all stores collectively. The second processing data may include the second transaction performance (S2) for each commodity for each predetermined period in the target period in each area.

The third data processing unit 117 obtains a comparison of the first processing data and the second processing data. For example, the third data processing unit 117 obtains a comparison result of transaction performance for each commodity based on the first transaction performance (S1) and the second transaction performance (S2). In the example, the comparison result is a price difference between the first transaction performance (S1) and the second transaction performance (S2). Hereinafter, the price difference between the first transaction performance (S1) and the second transaction performance (S2) is also referred to as a transaction price difference. The transaction price difference corresponds to a sales price difference between a specific retailer and other retailers or a grouping of retailers. Here, the transaction price difference is described as one example of the comparison of transaction performance, but is not limited thereto. The comparison of transaction performance may be a difference related to the transaction quantity of the number of persons involved in transactions, in addition to or instead of the difference related to the price.

The third data processing unit 117 obtains a calculation result using the comparison result of the processing data for each commodity. For example, the third data processing unit 117 obtains a value of the product of the transaction price difference and the first transaction performance (T). Hereinafter, the value obtained by multiplying the transaction price difference and the first transaction performance (T) is also referred to as a transaction amount difference. The transaction amount difference corresponds to a sales amount difference from the viewpoint of sales by stores. The sales amount difference is an index indicating an influence on sales of a specific retailer due to the sales price difference. The sales amount difference is an amount obtained by multiplying the sales price difference by the sales quantity of the specific retailer. Here, the value obtained by multiplying the transaction price difference and the first transaction performance (T) is described as an example of the calculation result using the comparison result of the processing data, and the embodiment is not limited thereto. The calculation result using the comparison result of the processing data may be a value using the first transaction performance different from the first transaction performance (T). The calculation result using the comparison result of the processing data may be a value using the comparison result of the processing data different from the transaction price difference.

The display of the “first price check” can include a display based on the transaction price difference for each commodity in relation to the sales price difference for each commodity.

By viewing the display based on the transaction price difference, the user can view the sales price difference corresponding to the transaction price difference. Accordingly, the user can easily grasp the sales price difference. The user can consider appropriateness of the sales price for each commodity at the specific retailer based on the sales price difference of each commodity. The user can appropriately grasp a degree to which the sales price difference affects the sales amount difference by checking the sales price difference at the specific retailer along with the sales amount difference.

The display of the “first price check” can include a display based on the transaction amount difference for each commodity in relation to the sales amount difference for each commodity.

By viewing the display based on the transaction amount difference, the user can view the sales amount difference corresponding to the transaction amount difference. Accordingly, the user can easily grasp the sales amount difference useful for operation of the store without performing calculation by himself or herself.

The display of the “first price check” can include a display based on the first transaction performance (S1) for each commodity in relation to the sales price for each commodity at the specific retailer.

By viewing the display based on the first transaction performance (S1), the user can view the sales price at the specific retailer corresponding to the first transaction performance (S1) used for calculating the transaction price difference. Accordingly, the user can appropriately grasp the transaction status at the specific retailer with respect to the sales price of the commodity by checking the sales price at the specific retailer along with the sales price difference.

The display of the “first price check” can include a display based on the first transaction performance (T) for each commodity in relation to the sales quantity for each commodity at the specific retailer.

By viewing the display based on the first transaction performance (T), the user can view the sales quantity at the specific retailer corresponding to the first transaction performance (T) used for calculating the transaction amount difference. Accordingly, the user can appropriately grasp a degree to which the sales quantity affects the sales amount difference by checking the sales quantity at a specific retailer along with the sales amount difference.

The display of the “first price check” can include a display based on the second transaction performance (S2) for each commodity in relation to the sales price for each commodity in a plurality of retailers.

By viewing the display based on the second transaction performance (S2), the user can view the sales price in the plurality of retailers corresponding to the second transaction performance (S2) used for calculating the transaction price difference. Accordingly, the user can appropriately grasp the transaction status in the public with respect to the sales price of the commodity by checking the sales price in the plurality of retailers along with the sales price difference.

Here, the display based on the first t transaction performance (S1) and the display based on the first transaction performance (T) are described as an example of the display based on the first transaction performance, and the embodiment is not limited thereto. The first transaction performance may include a value different from the first transaction performance (S1) and the first transaction performance (T). Here, the display based on the second transaction performance (S2) is described as an example of the display based on the second transaction performance, and the embodiment is not limited thereto. The second transaction performance may include a value different from the second transaction performance (S2).

The retailer can consider the appropriateness of the sales price for each commodity at the retailer based on the content of “first price check”.

A display example for a “first price check” will be described.

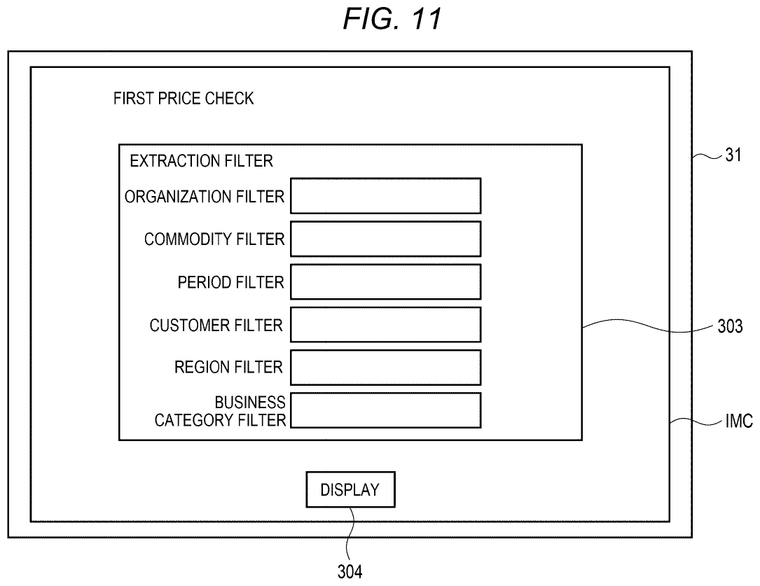

FIG. 11 is a diagram showing an example of an image for inputting the second extraction condition for the second type content displayed on the display device 31 of the terminal 3.

The display device 31 displays an image IMC for inputting the second extraction condition for the second type content. Here, the second type content is for the first price check”. The second extraction condition is a condition to be input for displaying a “first price check” image on the display device 31.

The image IMC includes an area 303 in which the second extraction condition can be input. The area 303 includes an area for “organization filter”, an area for “commodity filter”, an area for “period filter”, an area for “customer filter”, an area for “region filter”, and an area for “business category filter”. The area for “organization filter” is an area in which conditions related to a store owned by a specific retailer can be input. The area for “commodity filter” is an area in which conditions related to a commodity can be input. The area for “period filter” is an area in which conditions related to a period can be input. The area for “customer filter” is an area in which conditions related to a customer attribute can be input. The area for “region filter” is an area in which a specific area or a specific store can be input among conditions related to a store owned by a retailer to be compared. The area for “business category filter” is an area in which a specific business category can be input among conditions related to a store owned by a retailer to be compared.

The image IMC includes a “display” button 304 for an output instruction.

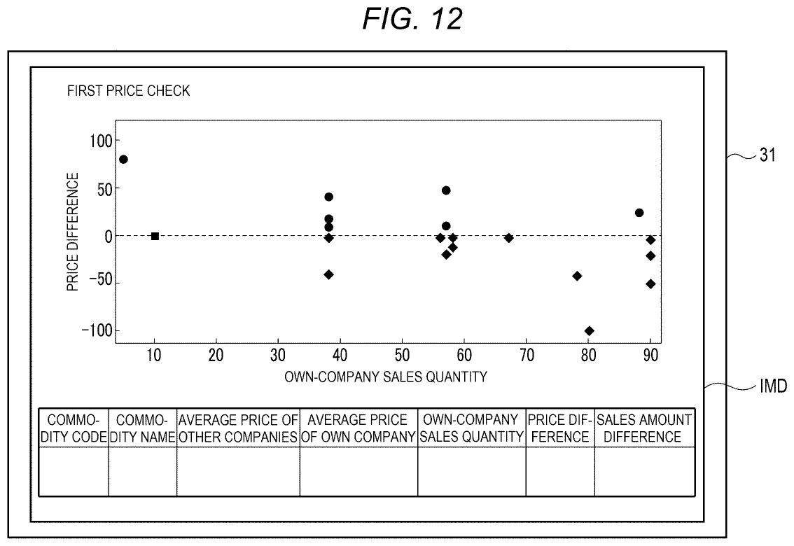

FIG. 12 is a diagram showing an example of an image of a first example of the second type content displayed on the display device 31 of the terminal 3.

The display device 31 displays an image IMD of the second type content based on the display information. It is assumed that the display information is generated by the server 1 based on the second extraction condition input in the image IMC shown in FIG. 11. Here, the second type content is the content of “first price check”. Here, each value is a value in the entire target period.

The image IMD displays a relationship between the transaction price difference and the first transaction performance (T) in a scatter diagram format as a relationship between an “own-company sales quantity” and a “price difference” for the content of “first price check”. The “own-company sales quantity” on a horizontal axis of the scatter diagram indicates the sales quantity at a specific retailer. The “price difference” on a vertical axis of the scatter diagram indicates the sales price difference. The display in the scatter diagram format regarding the relationship between the “own-company sales quantity” and the “price difference” is an example of the display based on the transaction price difference or the display based on the first transaction performance (T).

The image IMD indicates information on each commodity in a table format.

The table includes, for each commodity, information on “commodity code”, “commodity name”, “average price of other companies”, “average price of own company”, “own-company sales quantity”, “price difference”, and “sales amount difference”.

The “commodity code” indicates a commodity code of a commodity. The “commodity name” indicates a name of a commodity. The “average price of other companies” indicates the second transaction performance (S2) as a sales price in a plurality of retailers. The display of the “average price of other companies” is an example of the display based on the second transaction performance (S2). The “average price of own company” indicates the first transaction performance (S1) as a sales price at a specific retailer. The display of the “average price of own company” is an example of the display based on the first transaction performance (S1). The “own-company sales quantity” indicates the first transaction performance as a sales quantity at a specific retailer. The display of the “own-company sales quantity” is an example of the display based on the first transaction performance (T). The “price difference” indicates the transaction price difference as the sales price difference. The display of the “price difference” is an example of the display based on the transaction price difference. The “sales amount difference” indicates the transaction amount difference as the sales amount difference. The display of the “sales amount difference” is an example of the display based on the transaction amount difference.

The content of “second price check” will be described.

The content of “second price check” is the second example described above.

The “second price check” is content related to the sales performance at a specific retailer for each commodity and the corresponding sales performance at a plurality of other retailers or the like. For example, the sales performance includes the sales quantity, the sales total, the sales price, and a growth rate. The growth rate is a ratio indicating how much the sales quantity in a later period is increased compared to the sales quantity in a previous period. The growth rate may use the sales total instead of the sales quantity.

In the example, the first transaction performance can include first transaction performance (U1). The first transaction performance (U1) is an aggregation value obtained by summing up the transaction quantities for each commodity. The first transaction performance (U1) corresponds to the sales quantity for each commodity at a specific retailer by store. The first processing data includes the first transaction performance (U1) on a per processing unit basis. The third data processing unit 117 can obtain the first transaction performance (U1) based on the transaction quantity included in the second POS data. Since the first transaction performance (U1) changes according to the transaction quantity, the first transaction performance is an example of a first value according to the transaction quantity of the commodity.

The first transaction performance can include first transaction performance (V1). The first transaction performance (V1) is an aggregation value obtained by summing up the transaction amounts for each commodity. The first transaction performance (V1) corresponds to the sales for each commodity at a specific retailer by store. The first processing data includes the first transaction performance (V1) on a per processing unit basis. The third data processing unit 117 can obtain the first transaction performance (V1) based on the transaction amount included in the second POS data. The first transaction performance (V1) is an example of a first total transaction amount for commodities obtained by summing up the transaction amounts included in the second POS data. Since the first transaction performance (V1) changes according to the transaction quantity, the first transaction performance is an example of the first value according to the transaction quantity of the commodity.

The first transaction performance can include first transaction performance (W1). The first transaction performance (W1) is a statistical value obtained by averaging the transaction prices for each commodity. The statistical value is an average value. The first transaction performance (W1) corresponds to the sales price for each commodity at a specific retailer by store. The first processing data includes the first transaction performance (W1) on a per processing unit basis. The third data processing unit 117 can obtain the first transaction performance (W1) based on the transaction price included in the second POS data. The first transaction performance (W1) in the second example is an example of the first transaction price of the commodity.

The first transaction performance can include first transaction performance (X1). The first transaction performance (X1) is a statistical value indicating a change ratio of the first transaction performance (U1) along a time series for each commodity. The change ratio is a value obtained by dividing the first transaction performance (U1) in a later predetermined period along the time series of the two consecutive predetermined periods by the first transaction performance (U1) in a previous predetermined period. The first transaction performance (X1) may be a statistical value indicating a change ratio of the first transaction performance (V1) instead of the first transaction performance (U1). The first transaction performance (X1) corresponds to the growth rate for each commodity at a specific retailer by store. The first processing data includes the first transaction performance (X1) on a per processing unit basis. The third data processing unit 117 can obtain the first transaction performance (X1) based on the transaction quantity and the transaction amount included in the second POS data. The first transaction performance (X1) is an example of a first change ratio of the first value along the time series.

For example, the first processing data may include all or a part of the first transaction performance (U1), the first transaction performance (V1), and the first transaction performance (W1) for each commodity in the entire target period for all stores collectively. The first processing data may include all or a part of the first transaction performance (U1), the first transaction performance (V1), and the first transaction performance (W1) for each commodity for each predetermined period for all stores collectively. The first processing data may include at least one first transaction performance (X1) for each commodity for all stores collectively. The at least one first transaction performance (X1) may include a plurality of sets of first transaction performance (X1) each including two consecutive predetermined periods in the target period as a set. The at least one first transaction performance (X1) may include only the first transaction performance (X1) including a set of the latest predetermined period along the time series in the target period and the predetermined period immediately before the predetermined period.

In the example, the second transaction performance can include second transaction performance (U2). The second transaction performance (U2) is an aggregation value obtained by summing up the transaction quantities for each commodity. The second transaction performance (U2) corresponds to the sales quantity for each commodity in a plurality of retailers from the viewpoint of sales by the store. The second processing data includes the second transaction performance (U2) on a per processing unit basis. The third data processing unit 117 can obtain the second transaction performance (U2) based on the transaction quantity included in the receipt data. Since the second transaction performance (U2) changes according to the transaction quantity, the second transaction performance is an example of a second value according to the transaction quantity of the commodity.

The second transaction performance can include second transaction performance (V2). The second transaction performance (V2) is an aggregation value obtained by summing up the transaction amounts for each commodity. The second transaction performance (V2) corresponds to the sales for each commodity in a plurality of retailers from the viewpoint of sales by the store. The second processing data includes the second transaction performance (V2) on a per processing unit basis. The third data processing unit 117 can obtain the second transaction performance (V2) based on the transaction amount obtained by multiplying the transaction price and the transaction quantity included in the receipt data. The second transaction performance (V2) is an example of a second total transaction amount for commodities obtained by summing up the transaction amounts. Since the second transaction performance (V2) changes according to the transaction quantity, the second transaction performance is an example of the second value according to the transaction quantity of the commodity.

The second transaction performance can include second transaction performance (W2). The second transaction performance (W2) is a statistical value obtained by averaging the transaction prices for each commodity. The statistical value is an average value. The second transaction performance (W2) corresponds to the sales price for each commodity in a plurality of retailers from the viewpoint of sales by the store. The second processing data includes the second transaction performance (W2) on a per processing unit basis. The third data processing unit 117 can obtain the second transaction performance (W2) based on the transaction price included in the receipt data. The second transaction performance (W2) is an example of the second transaction price of the commodity in the second example.

The second transaction performance can include second transaction performance (X2). The second transaction performance (X2) is a statistical value indicating a change ratio of the second transaction performance (U2) along a time series for each commodity. The change ratio is a value obtained by dividing the second transaction performance (U2) in a later predetermined period along the time series of the two consecutive predetermined periods by the second transaction performance (U2) in a previous predetermined period. The second transaction performance (X2) may be a statistical value indicating a change ratio of the second transaction performance (V2) instead of the second transaction performance (U2). The second transaction performance (X2) corresponds to a growth rate for each commodity in a plurality of retailers from the viewpoint of sales by the store. The second processing data includes the second transaction performance (X2) on a per processing unit basis. The third data processing unit 117 can obtain the second transaction performance (X2) based on the transaction quantity included in the receipt data or the transaction amount obtained by multiplying the transaction price and the transaction quantity. The second transaction performance (X2) is an example of a second change ratio of the second value along the time series.

For example, the second processing data may include all or a part of the second transaction performance (U2), the second transaction performance (V2), and the second transaction performance (W2) for each commodity in the entire target period for all stores collectively. The second processing data may include all or a part of the second transaction performance (U2), the second transaction performance (V2), and the second transaction performance (W2) for each commodity for each predetermined period for all stores collectively. The second processing data may include at least one second transaction performance (X2) for each commodity for all stores collectively. The at least one second transaction performance (X2) may include a plurality of sets of second transaction performance (X2) each including two consecutive predetermined periods in the target period as a set. The at least one second transaction performance (X2) may include only the second transaction performance (X2) including a set of the latest predetermined period along the time series in the target period and the predetermined period immediately before the predetermined period.

The display of a “second price check” can include a display based on the first transaction performance (U1) for each commodity in relation to the sales quantity for each commodity at the specific retailer. The display based on the first transaction performance (U1) may be a display based on the first transaction performance (U1) in the entire target period. The display based on the first transaction performance (U1) may be a display based on the first transaction performance (U1) for each predetermined period in the target period.

The display of a “second price check” can include a display based on the first transaction performance (V1) for each commodity at the specific retailer. The display based on the first transaction performance (V1) may be a display based on the first transaction performance (V1) in the entire target period. The display based on the first transaction performance (V1) may be a display based on the first transaction performance (V1) for each predetermined period in the target period.

The display of a “second price check” can include a display based on the first transaction performance (W1) for each commodity at the specific retailer. The display based on the first transaction performance (W1) may be a display based on the first transaction performance (W1) in the entire target period. The display based on the first transaction performance (W1) may be a display based on the first transaction performance (W1) for each predetermined period in the target period.

The display of a “second price check” can include a display based on at least one first transaction performance (X1) for each commodity in relation to a growth rate for each commodity at the specific retailer.

The display of a “second price check” can include a display based on the second transaction performance (U2) for each commodity in relation to the sales quantity for each commodity in the plurality of retailers. The display based on the second transaction performance (U2) may be a display based on the second transaction performance (U2) in the entire target period. The display based on the second transaction performance (U2) may be a display based on the second transaction performance (U2) for each predetermined period in the target period.

The display of a “second price check” can include a display based on the second transaction performance (V2) for each commodity in relation to the sales for each commodity in the plurality of retailers. The display based on the second transaction performance (V2) may be a display based on the second transaction performance (V2) in the entire target period. The display based on the second transaction performance (V2) may be a display based on the second transaction performance (V2) for each predetermined period in the target period.

The display of a “second price check” can include a display based on the second transaction performance (W2) for each commodity in relation to the sales price for each commodity in the plurality of retailers. The display based on the second transaction performance (W2) may be a display based on the second transaction performance (W2) in the entire target period. The display based on the second transaction performance (W2) may be a display based on the second transaction performance (W2) for each predetermined period in the target period.

The display of a “second price check” can include a display based on at least one second transaction performance (X2) for each commodity in relation to a growth rate for each commodity in the plurality of retailers.

Using the display based on the first transaction performance (U1) and the display based on the second transaction performance (U2), the user can grasp, for each commodity, the sales quantity at a specific retailer while comparing the sales quantity with the sales quantity in public. For example, the user can grasp, for each commodity, a trend in the sales quantity at a specific retailer along the time series while comparing the trend in the sales quantity in the public along the time series.

Using the display based on the first transaction performance (V1) and the display based on the second transaction performance (V2), the user can grasp, for each commodity, the sales at a specific retailer in comparison to public sales. For example, the user can grasp, for each commodity, trend in the sales at a specific retailer over time while comparing the trend in the sales in the public over time.

Using the display based on the first transaction performance (W1) and the display based on the second transaction performance (W2), the user can grasp, for each commodity, the sales price at a specific retailer while comparing the sales price to public sales data. The user can consider, for each commodity, a difference in trend in the sales or the sales quantity between the retailer and the public sales data.

Using the display based on the first transaction performance (X1) and the display based on the second transaction performance (X2), the user can grasp, for each commodity, the growth rate at the specific retailer while comparing the growth rate with the growth rate in the public. Using the growth rate, the user can grasp in detail the difference in the trend in sales or sales quantity over time for each commodity.

The display of a “second price check” is not limited to the above-described example. The first transaction performance may include a value different from the first transaction performance (U1), the first transaction performance (V1), the first transaction performance (W1), and the first transaction performance (X1). The second transaction performance may include a value different from the second transaction performance (U2), the second transaction performance (V2), the second transaction performance (W2), and the second transaction performance (X2).

Using the content of “second price check”, the retailer can compare, for each commodity, the transaction status at the retailer against other public sales.

A display example of a “second price check” will be described.

A display example of an image for inputting a second extraction condition for a “second price check” is generally the same for “first price check” described with reference to FIG. 11.

The display of the “second price check” is assumed to display information about a specific retailer and information about a plurality of retailers in different browser windows or the like.

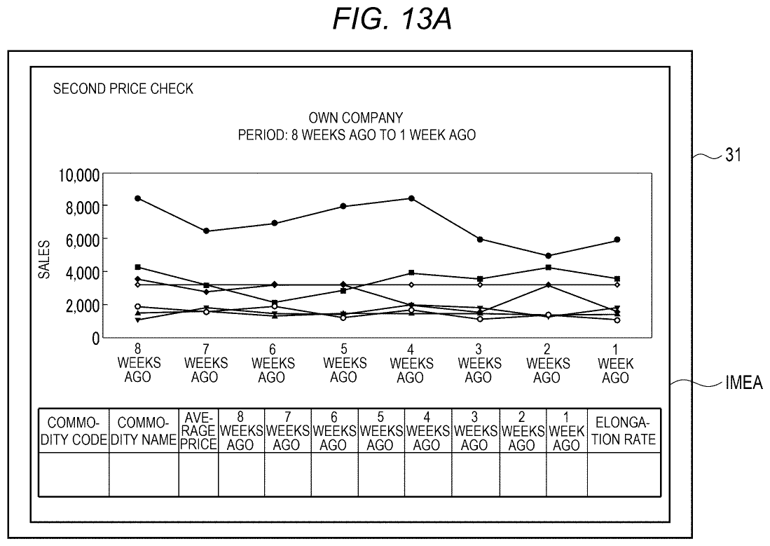

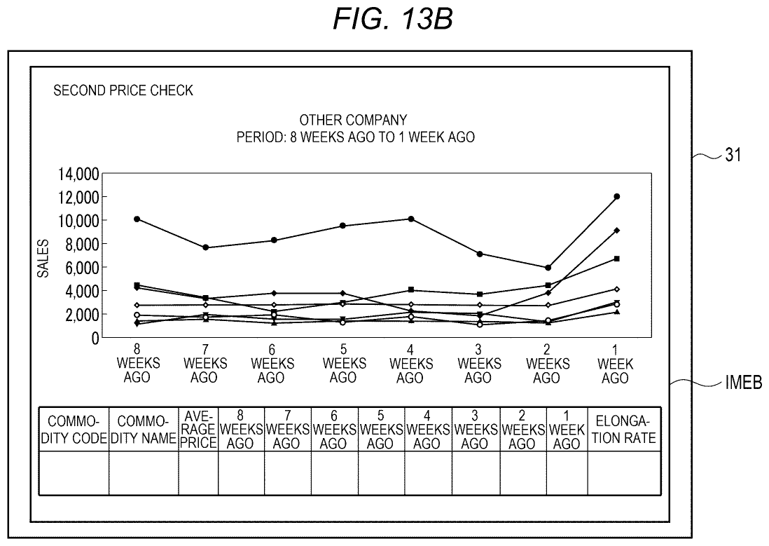

FIG. 13A is a diagram showing an example of an image of a second example of the second type content displayed on the display device 31 of the terminal 3.

The display device 31 displays an image IMEA of the second type content based on the display information. It is assumed that the display information is generated by the server 1 based on the second extraction condition. The image IMEA is an image displaying information on a specific retailer. Here, the second type content is the content of “second price check”. Here, each value is a value for each predetermined period in the target period. The predetermined period is one week.

The image IMEA displays, for the content of “second price check”, and in the line graph format, the first transaction performance (V1) for each predetermined period in the target period as “sales” for each predetermined period in the target period. The “sales” on a vertical axis of the line graph indicates sales at the specific retailer. The display for the “sales” in the line graph format is an example of the display based on the first transaction performance (V1).

The image IMEA indicates information on each commodity in a table format.

The table includes, for each commodity, information on “commodity code”, “commodity name”, “average price”, “8 weeks ago” to “1 week ago”, and “elongation rate”.

The “commodity code” indicates a commodity code of a commodity. The “commodity name” indicates a name of a commodity. The “average price” indicates the first transaction performance (W1) as a sales price at a specific retailer. The display of the “average price” is an example of the display based on the first transaction performance (W1). The “8 weeks ago” to “1 week ago” indicate the first transaction performance (V1) for each predetermined period in the target period as the sales at the specific retailer. The display of the “8 weeks ago” to “1 week ago” is an example of the display based on the first transaction performance (V1). The “elongation rate” indicates the first transaction performance (X1) as a growth rate at a specific retailer over a time period. Here, the “elongation rate” indicates how much the sales “1 week ago” has increased as compared to the sales “2 weeks ago”. The display of the “elongation rate” may be referred to as a growth trend display or sales trend and is an example of a display based on the first transaction performance (X1).

FIG. 13B is a diagram showing another example of the image of the second example of the second type content displayed on the display device 31 of the terminal 3.

The display device 31 displays an image IMEB of the second type content based on the display information. It is assumed that the display information is generated by the server 1 based on the second extraction condition. The image IMEB is an image displaying information on a plurality of retailers. Here, the second type content is the content of “second price check”. Here, each value is a value for each predetermined period in the target period. The predetermined period is one week.

The image IMEB displays, for the content of “second price check”, the second transaction performance (V2) for each predetermined period in the target period as “sales” for each predetermined period in the target period in the line graph format. The “sales” on a vertical axis of the line graph indicates sales at the specific retailer. The display for the “sales” in the line graph format is an example of the display based on the second transaction performance (V2).

The image IMEB indicates information on each commodity in a table format.

The table includes, for each commodity, information on “commodity code”, “commodity name”, “average price”, “8 weeks ago” to “1 week ago”, and “elongation rate”.

The “commodity code” indicates a commodity code of a commodity. The “commodity name” indicates a name of a commodity. The “average price” indicates the second transaction performance (W2) as a sales price at a specific retailer. The display of the “average price” is an example of the display based on the second transaction performance (W2). The “8 weeks ago” to “1 week ago” indicate the second transaction performance (V2) for each predetermined period in the target period as sales at the specific retailer. The display of the “8 weeks ago” to “1 week ago” is an example of the display based on the second transaction performance (V2). The “elongation rate” indicates the second transaction performance (X2) as a growth rate at a specific retailer. Here, the “elongation rate” indicates how much the sales “1 week ago” has increased as compared to the sales “2 weeks ago”. The display of the “elongation rate” is an example of a display based on the second transaction performance (X2).

The content of “new commodity check” will be described.

The content of “new commodity check” is the third example described above.

The content of “new commodity check” relates to a target commodity that is transacted in the public but is not transacted at the specific retailer.

The third data processing unit 117 aggregates, using the commodity code included in the second POS data, a plurality of pieces of second POS data satisfying the first extraction condition on a per commodity item basis. The third data processing unit 117 generates the first processing data by aggregating the plurality of pieces of second POS data on a per commodity item basis.

The first processing data can include a commodity code for each commodity. The commodity code for each commodity included in the first processing data is a commodity code of a commodity transacted by a specific retailer. The commodity code for each commodity included in the first processing data is an example of a transaction status indicating a state of a transaction performed by specific retailer. The first processing data can include the first transaction performance for each commodity.

The third data processing unit 117 aggregates, using the commodity code included in the receipt data, a plurality of pieces of receipt data satisfying the second extraction condition on a per commodity item basis. The third data processing unit 117 generates the second processing data by aggregating the plurality of pieces of receipt data on a per commodity item basis.

The second processing data can include a commodity code for each commodity. The commodity code for each commodity included in the second processing data is a commodity code of a commodity transacted by at least one retailer among a plurality of retailers. The commodity code for each commodity included in the second processing data is an example of a transaction status indicating a state of a transaction made in the public. The second processing data can include the second transaction performance for each commodity. The second transaction performance can include second transaction performance (Y). The second transaction performance (Y) is a statistical value obtained by the transaction price for each commodity. For example, the statistical value is an average value obtained by averaging the transaction prices, and may be a highest value, a lowest value, a mode, a median, or the like of the transaction prices. The second transaction performance (Y) corresponds to the sales prices in the plurality of specific retailers from the viewpoint of sales by the store. For example, the sales price in the plurality of retailers is an average value, and may be a highest value, a lowest value, a mode, a median, or the like. The third data processing unit 117 can obtain the second transaction performance (Y) based on the transaction price included in the receipt data. The second transaction performance (Y) is an example of a transaction price of a commodity in the third example.

The second transaction performance can include second transaction performance (ZA). The second transaction performance (ZA) is an aggregation value obtained by uniquely counting company codes for each commodity. In the example, the second transaction performance (ZA) corresponds to the number of retailers selling commodities from the viewpoint of sales by the store. The third data processing unit 117 can obtain the second transaction performance (ZA) based on the company code included in the receipt data. The second transaction performance (ZA) is an example of the number of retailers in which the commodity is transacted.

The second transaction performance can include second transaction performance (ZB). The second transaction performance (ZB) is an aggregation value obtained by uniquely counting store codes for each commodity. In the example, the second transaction performance (ZB) corresponds to the number of stores selling commodities from the viewpoint of sales by the store. The third data processing unit 117 can obtain the second transaction performance (ZB) based on the store code included in the receipt data. The second transaction performance (ZB) is an example of the number of stores in which the commodity is transacted.

For example, the second processing data may include all or a part of the second transaction performance (Y), the second transaction performance (ZA), and the second transaction performance (ZB) for each commodity in the entire target period for all stores collectively. The second processing data may include all or a part of the second transaction performance (Y), the second transaction performance (ZA), and the second transaction performance (ZB) for each commodity in the entire target period in each area. The second processing data may include all or a part of the second transaction performance (Y), the second transaction performance (ZA), and the second transaction performance (ZB) for each commodity for each predetermined period in the target period.

The third data processing unit 117 compares the commodity code of each commodity included in the first processing data with the commodity code of each commodity included in the second processing data. By comparing the commodity codes, the third data processing unit 117 acquires the commodity code of each target commodity not included in the first processing data in the second processing data. The third data processing unit 117 can acquire information such as a name, a category, and a manufacturer of the target commodity based on the commodity code of each target commodity. The third data processing unit 117 can acquire the second transaction performance for each target commodity based on the second processing data. The third data processing unit 117 generates the display information for displaying the target commodity for the content of “new commodity check”.

The display of the “new commodity check” can include display of information for identifying the target commodity. The display of the “new commodity check” can include display of the Category of the target commodity. The display of the “new commodity check” can include display of the manufacturer of the target commodity.

The display of the “new commodity check” can include a display based on the second transaction performance (Y) of the target commodity in relation to the sales price for each target commodity at a plurality of retailers.

The user can view the sales prices in the plurality of retailers corresponding to the second transaction performance (Y) by viewing the display based on the second transaction performance (Y). Accordingly, the user can easily grasp how many target commodities are sold in the public.

The display of the “new commodity check” can include a display based on the second transaction performance (ZA) of the target commodity in relation to the number of retailers for each target commodity.

By viewing the display based on the second transaction performance (ZA), the user can view the number of retailers corresponding to the second transaction performance (ZA). Accordingly, the user can easily grasp how many retailers in the public sell the target commodity.

The display of the “new commodity check” can include a display based on the second transaction performance (ZB) of the target commodity in relation to the number of stores for each target commodity.

By viewing the display based on the second transaction performance (ZB), the user can view the number of stores corresponding to the second transaction performance (ZB). Accordingly, the user can easily grasp how many stores in the public sell the target commodity.

The retailer can grasp the transaction status for commodities, which are not sold by the retailer, in the public using the content of “new commodity check”.

A display example for the content of “new commodity check” will be described.

A display example of an image for inputting the second extraction condition for the content of “new commodity check” is generally the same as the display example of the “first price check” described with reference to FIG. 11.

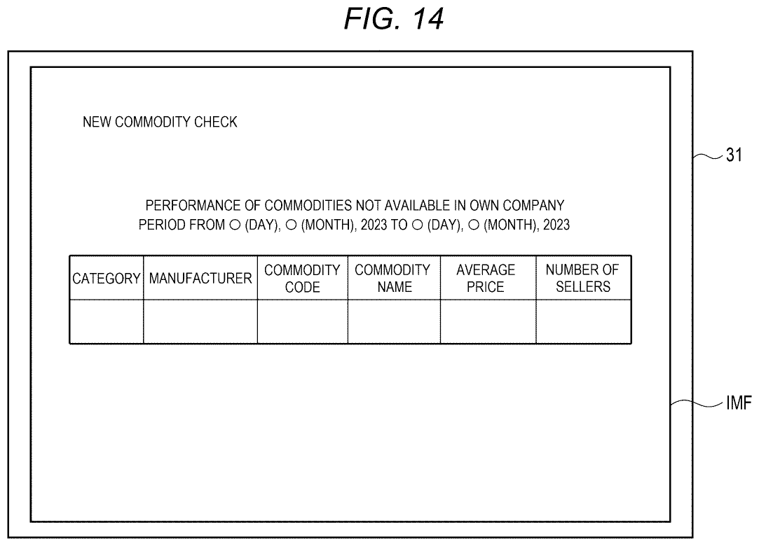

FIG. 14 is a diagram showing an example of an image of a third example of the second type content displayed on the display device 31 of the terminal 3.

The display device 31 displays an image IMF of the second type content based on the display information. It is assumed that the display information is generated by the server 1 based on the second extraction condition. Here, the second type content is the content of “new commodity check”.

The image IMF indicates information on each target commodity in a table format.

The table includes, for each target commodity, information on “category”, “manufacturer”, “commodity code”, “commodity name”, “average price”, and “number of sellers”.

The “category” indicates a category of a target commodity. The “manufacturer” indicates a manufacturer of a target commodity. The “commodity code” indicates a commodity code of a target commodity. The “commodity name” indicates a name of a target commodity. The “average price” indicates the second transaction performance (Y) as a sales price in a plurality of retailers. The display of the “average price” is an example of the display based on the second transaction performance (Y). The “number of sellers” indicates the second transaction performance (ZA) as the number of retailers. The display of the “number of sellers” is an example of the display based on the second transaction performance (ZA).

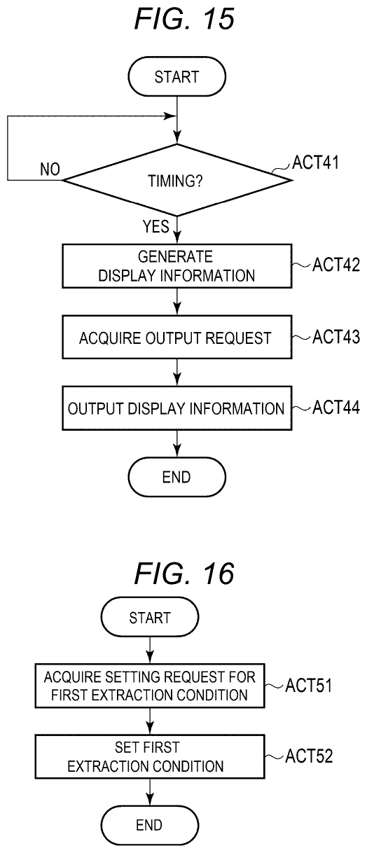

FIG. 15 is a flowchart showing another example of the output processing of the display information performed by the processing circuit 11 of the server 1.

Here, it is assumed that the first extraction condition is set for the first type content of the retailer.

The third data processing unit 117 detects that a predetermined timing set in the first type content is reached (ACT 41). If the predetermined timing is reached (ACT 41, NO), the third data processing unit 117 continues the processing of ACT 41. If the predetermined timing is not reached (ACT 41, YES), the processing transitions from ACT 41 to ACT 42.

The third data processing unit 117 generates the display information based on the pieces of second POS data (ACT 42). In ACT 42, similarly to ACT 33, the third data processing unit 117 searches the POS data storage area 132 for the pieces of second POS data satisfying the first extraction condition indicated by the setting information. The third data processing unit 117 generates the display information based on the pieces of second POS data satisfying the first extraction condition.

The third communication processing unit 116 acquires an output request (ACT 43). In ACT 43, the third communication processing unit 116 acquires the output request from the terminal 3 via the communication interface 14. Here, it is assumed that the user of the retailer accesses the server 1 using the terminal 3 to display the first type content selected on the terminal 3. The user inputs an output instruction using the terminal 3. The terminal 3 outputs the output request to the server 1 based on the output instruction given by the user using the terminal 3.

The third communication processing unit 116 outputs the display information generated by the third data processing unit 117 (ACT 44). In ACT 44, the third communication processing unit 116 outputs the display information to the terminal 3 via the communication interface 14. The terminal 3 displays an image of the first type content based on the display information.

The same applies to a case in which the second extraction condition is set for a certain second type content of a certain retailer. In this case, in the description using FIG. 15, the notation “first extraction condition” may be replaced as the “second extraction condition”. The notation “first type content” may be replaced as the “second type content”. In ACT 42, the third data processing unit 117 generates the display information based on the plurality of pieces of second POS data and the plurality of receipt data based on the setting information on the second extraction condition. The processing in ACT 42 may be the same as the processing in ACT 35.

Here, the user of the retailer is described as an example, and the same applies to a user of another vendor. In this case, in the description with reference to FIG. 15, the notation “user of retailer” may be replaced as “user of another vendor”. The plurality of pieces of second POS data used for generating the display information are pieces of data in which the use authority is set to another vendor. Therefore, the plurality of pieces of second POS data are pieces of data for a specific retailer different from another vendor. The plurality of pieces of second POS data may be data for the same retailer. The plurality of pieces of second POS data may be data set for two or more retailers, depending on the number of use authority set for another vendor.

Setting processing of the extraction condition performed by the processing circuit 11 of the server 1 will be described.

FIG. 16 is a flowchart showing an example of the setting processing of the first extraction condition performed by the processing circuit 11 of the server 1.

Here, the user of the retailer accesses the server 1 using the terminal 3 in order to set the first extraction condition for any first type content. The user uses the terminal 3 to input the first extraction condition for the first type content. For example, it is assumed that the user uses the terminal 3 to input a condition related to a store owned by the retailer. After inputting the first extraction condition, the user inputs a setting instruction for the first extraction condition using the terminal 3. The terminal 3 outputs a setting request for the first extraction condition and the extraction condition to the server 1 based on the input of the setting instruction by the user using the terminal 3. The setting request for the first extraction condition is a request for causing the server 1 to set the first extraction condition.

The third communication processing unit 116 acquires the setting request for the first extraction condition and the input information on the extraction condition (ACT 51). In ACT 51, the third communication processing unit 116 acquires the setting request for the first extraction condition and the input information on the extraction condition from the terminal 3 via the communication interface 14.

The third data processing unit 117 sets the first extraction condition based on the operation of the terminal 3 performed by the user (ACT 52). In ACT 52, the third data processing unit 117 sets the first extraction condition indicated by the input information for the first type content for the retailer. The third data processing unit 117 stores, in the setting information storage area 134, the setting information on the set first extraction condition.

Although the user of the retailer is described as an example, the user who operates the terminal 3 is not limited to the user of the retailer, and may be a user who is given authority set by the retailer.

As described above, the server 1 can set the first extraction condition based on the operation of the terminal 3 performed by the user.

As described above, by presetting the first extraction condition, the user of the retailer can omit inputting the first extraction condition when displaying the image of the first type content on the terminal 3.

Here, the user of the retailer is described as an example, and the same applies to a user of another vendor. In this case, in the description with reference to FIG. 16, the notation “user of retailer” may be replaced as “user of another vendor”. For example, it is assumed that the user uses the terminal 3 to input a condition related to a store owned by a specific retailer different from other vendors. In the example, the user who operates the terminal 3 is not limited to the user of another vendor, and may be any user who is given authority.

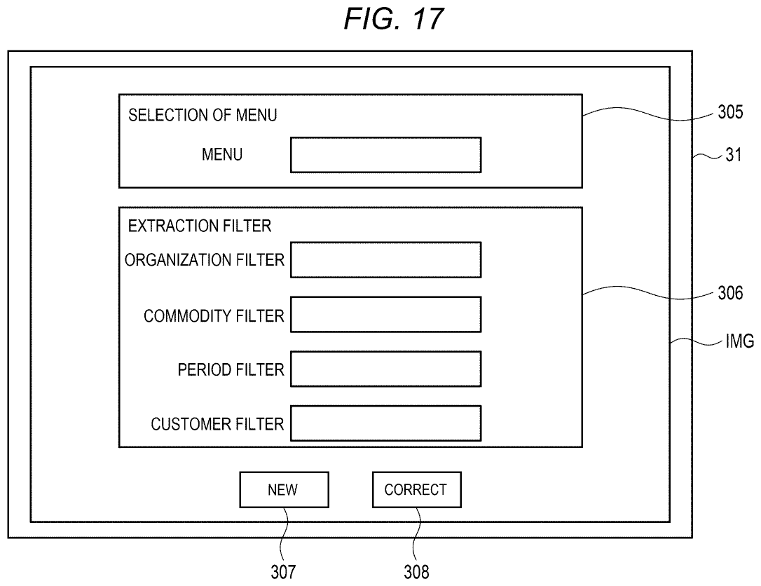

FIG. 17 is a diagram showing an example of an image for inputting the first extraction condition displayed on the display device 31 of the terminal 3.

The display device 31 displays an image IMG for inputting the first extraction condition set for the first type content.

The image IMG includes an area 305 in which a menu can be selected. In this context, the menu can be selected for setting particular types of extraction conditions such as the first extraction condition that might be related to content types such as the first type content.

An image IMG includes an area 306 in which the first extraction condition(s) can be input. The area 306 includes an area for “organization filter”, an area for “commodity filter”, an area for “period filter”, and an area for “customer filter”. The area for “organization filter” is an area in which conditions related to a store owned by a specific retailer can be input. The area for “commodity filter” is an area in which conditions related to a commodity can be input. The area for “period filter” is an area in which conditions related to a period can be input. The area for “customer filter” is an area in which conditions related to a customer attribute can be input.

The image IMG includes a “new” button 307 and a “correct” button 308 for inputting a setting instruction for the first extraction condition. The “new” button 307 is a button for inputting a setting instruction of a newly set first extraction condition. The “correct” button 308 is a button for inputting a setting instruction for updating the first extraction condition.

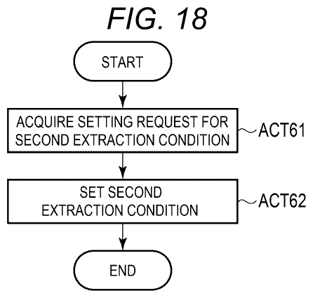

FIG. 18 is a flowchart showing an example of the setting processing of the second extraction condition performed by the processing circuit 11 of the server 1.

Here, the user of the retailer accesses the server 1 using the terminal 3 in order to set the second extraction condition for any second type content. The user uses the terminal 3 to input the second extraction condition for the second type content. For example, it is assumed that the user uses the terminal 3 to input a condition related to a store owned by the retailer. After inputting the second extraction condition, the user inputs a setting instruction for the second extraction condition using the terminal 3. The setting instruction for the second extraction condition is an instruction for causing the server 1 to set the second extraction condition. The terminal 3 outputs a setting request for the second extraction condition and the input information for the extraction condition to the server 1. The setting request for the second extraction condition is a request for causing the server 1 to set the second extraction condition.

The third communication processing unit 116 acquires the setting request of the second extraction condition and the input information on the extraction condition (ACT 61). In ACT 61, the third communication processing unit 116 acquires the setting request for the second extraction condition from the terminal 3 via the communication interface 14.

The third data processing unit 117 sets the second extraction condition based on the operation of the terminal 3 performed by the user (ACT 62). In ACT 62, the third data processing unit 117 sets the second extraction condition indicated by the input information for the second type content for the retailer. The third data processing unit 117 stores, in the setting information storage area 134, the setting information on the set second extraction condition.

Although the user of the retailer is described as an example, the user who operates the terminal 3 is not limited to the user of the retailer, and may be a user who is given authority set by the retailer.

As described above, the server 1 can set the second extraction condition based on the operation of the terminal 3 performed by the user.

As described above, by presetting the second extraction condition, the user of the retailer can omit inputting the second extraction condition when displaying the image of the second type content on the terminal 3.

Here, the user of the retailer is described as an example, and the same applies to a user of another vendor. In this case, in the description with reference to FIG. 18, the notation “user of retailer” may be replaced as “user of another vendor”. For example, it is assumed that the user uses the terminal 3 to input a condition related to a store owned by a specific retailer different from other vendors. In the example, the user who operates the terminal 3 is not limited to the user of another vendor, and may be a user who is given authority set by another vendor.

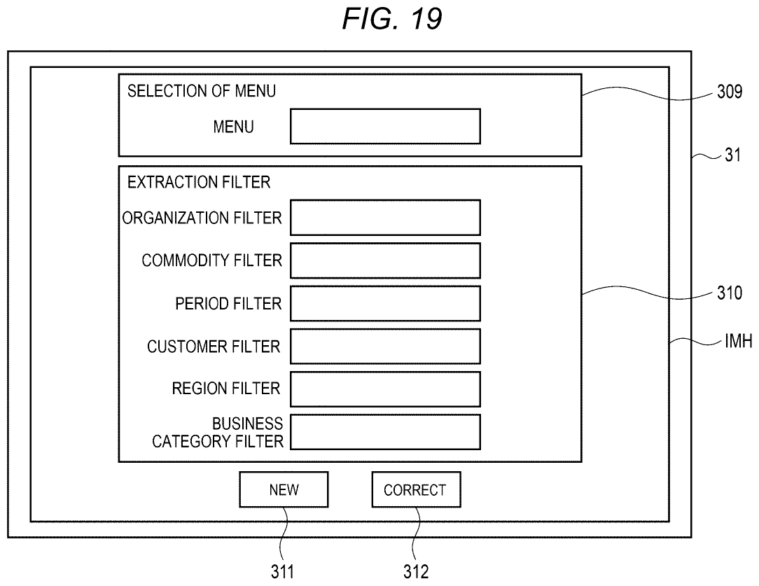

FIG. 19 is a diagram showing an example of an image for inputting the second extraction condition displayed on the display device 31 of the terminal 3.

The display device 31 displays an image IMH for inputting the second extraction condition set for the second type content.

The image IMH includes an area 309 in which a menu can be input. The menu is the second type content for setting the second extraction condition.

An image IMH includes an area 310 in which the second extraction condition can be input. The area 310 includes an area for “organization filter”, an area for “commodity filter”, an area for “period filter”, an area for “customer filter”, an area for “region filter”, and an area for “business category filter”. The area for “organization filter” is an area in which conditions related to a store owned by a specific retailer can be input. The area for “commodity filter” is an area in which conditions related to a commodity can be input. The area for “period filter” is an area in which conditions related to a period can be input. The area for “customer filter” is an area in which conditions related to a customer attribute can be input. The area for “region filter” is an area in which a specific area or a specific store can be input among conditions related to a store owned by a retailer to be compared. The area for “business category filter” is an area in which a specific business category can be input among conditions related to a store owned by a retailer to be compared.

The image IMH includes a “new” button 311 and a “correct” button 312 for inputting a setting instruction for the second extraction conditions. The “new” button 311 is a button for a setting instruction of a newly set second extraction condition. The “correct” button 312 is a button for inputting a setting instruction for updating a previously set second extraction condition.

Setting processing of the use authority performed by the processing circuit 11 of the server 1 will be described.

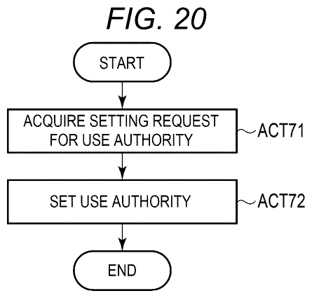

FIG. 20 is a flowchart showing an example of the setting processing of the use authority performed by the processing circuit 11 of the server 1.

Here, the user of the retailer accesses the server 1 by using the terminal 3 in order to set the use authority to another vendor. The user uses the terminal 3 to input the use authority for another vendor. Information indicating the use authority input using the terminal 3 based on the operation of the terminal 3 performed by the user is also referred to as input information on the use authority. The input information on the use authority includes information indicating another vendor. After inputting the use authority, the user inputs a setting instruction for the use authority using the terminal 3. The setting instruction for the use authority is an instruction for causing the server 1 to set the use authority. The terminal 3 outputs a setting request for the use authority and the input information on the use authority to the server 1. The setting request for the use authority is a request for causing the server 1 to set the use authority.

The third communication processing unit 116 acquires the setting request of the use authority and the input information related to the use authority (ACT 71). In ACT 71, the third communication processing unit 116 acquires the setting request for the use authority and the input information from the terminal 3 via the communication interface 14.

The third data processing unit 117 sets the use authority based on the operation of the terminal 3 performed by the user (ACT 72). In ACT 72, the third data processing unit 117 sets the use authority. The third data processing unit 117 stores the set use authority setting information in the setting information storage area 134.

Although a user from a retailer is described as an example, the user who operates a terminal 3 is not limited to a user from a retailer, and may be any user who is given authority as set by the retailer.

As described above, the server 1 can set the use authority of another vendor.

In this way, the server 1 can support the distribution of the POS data from the retailer to another vendor.

By using a platform provided by the server 1 that manages the POS data of the retailer, the retailer can easily distribute the POS data of the retailer to another vendor.

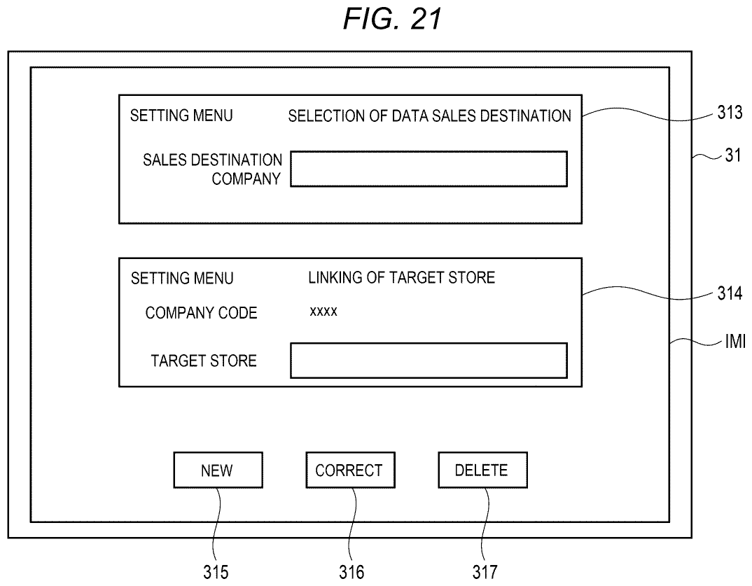

FIG. 21 is a diagram showing an example of an image displayed on the display device 31 of the terminal 3 for inputting use authority to be set to another vendor.

An image IMI includes an area 313 in which a sales destination company can be input. The sales destination company is another vendor to which the retailer gives use authority.

The image IMI includes an area 314 in which a range of the stores owned by the retailer can be input as the use authority.

The image IMI includes a “new” button 315 and a “correct” button 316 for inputting a setting instruction for a use authority. The “new” button 315 is a button for inputting a setting instruction for a new use authority for another vendor. The “correct” button 316 is a button for updating a previously set use authority of another vendor.

The image IMI includes a “delete” button 317 for inputting a use authority deletion instruction. The use authority deletion instruction causes the server 1 to delete a use authority.

### Effects

According to an embodiment, the server 1 can output the display information based on a plurality of pieces of second POS data and/or a plurality of pieces of receipt data.

Accordingly, the server 1 can provide a platform that enables viewing of images corresponding to various second type content based on the pieces of second POS data and the pieces of receipt data. Since the server 1 can collect the second POS data and the receipt data for various retailers, the server 1 can support a comparison between a specific retailer and other sales information publicly available.

According to the embodiment, the server 1 can output the display information based on a comparison between the first transaction performance data and the second transaction performance data.

Accordingly, by viewing the display based on the comparison between the first transaction performance data and the second transaction performance data, the user can easily see and understand the comparison between the first transaction performance data and the second transaction performance data. Therefore, the server 1 can support the comparison between the transactions at the specific retailer and the broader public transactions.

According to an embodiment, the server 1 can output display information based on the first transaction performance data and the second transaction performance data.

Accordingly, by viewing the display, the user can compare the first transaction performance data and the second transaction performance data. Thus, the user can compare the transactions at the specific retailer with the transactions among the public. Therefore, the server 1 can provide a comparison between the transactions at the specific retailer at others.

The server 1 can make it possible to view information about a target commodity that is transacted in the public but that is not transacted at the specific retailer.

### OTHER EMBODIMENTS

An embodiment may be implemented as a method executed by a system. An embodiment may be implemented as a software program of the like including program instructions enabling a computer (or a system of computers) to execute described functions. Such a program of an embodiment may be implemented as a non-transitory, computer-readable recording medium that stores the program.

A circuit or circuits constituting the processing circuit in an embodiment executes one or more processing among the plurality of described processing functions. When the processing circuit is implemented as a single circuit, the single circuit executes all of the processing. When the processing circuit comprises a plurality of circuits, each may execute a part of the processing. When the processing circuit includes a plurality of circuits, the plurality of circuits may be incorporated within in one device or may be distributed among a plurality of devices.

A program of an embodiment may be stored in a device and transferred to an end user or the like or transferred separately from a device. In the latter case, the program may be transferred via a network or recorded on a recording medium. The recording medium can be any non-transitory tangible medium that is computer readable. The recording medium format is not limited as long as it can store the program and can be read by a computer. For example, the recording medium may be a CD-ROM or a memory card.

While certain embodiments have been described, these embodiments have been presented by way of example only, and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in a scope of the disclosure disclosed in the claims and equivalents thereof.

What is claimed is:

1. An information processing system, comprising:
a server including:
a communication interface connectable to a network;
a storage device; and
a processor configured to:
receive point-of-sale data from a plurality point-of-sale devices via the network and store the point-of-sale data in the storage device;
receive receipt data from an electronic receipt server via the network and store the receipt data in the storage device;
generate display information based on stored point-of-sale data;
generate display information based on stored receipt data;
generate display information based on both the stored point-of-sale data and the stored receipt data; and
transmit generated display information to a user terminal via the network.

2. The information processing system according to claim 1, wherein
the plurality of point-of-sale devices generate the point-of-sale data for sales transactions of a single organization, and
the receipt data is for sales transactions of multiple organizations.

3. The information processing system according to claim 2, wherein the user terminal is operated by the single organization.

4. The information processing system according to claim 2, wherein the user terminal is operated by an entity other than the single organization.

5. The information processing system according to claim 4, the entity is a data analysis vendor granted use authority by the single organization.

6. The information processing system according to claim 1, wherein
the plurality of point-of-sale devices generate the point-of-sale data for sales transactions of multiple retailers,
the receipt data is for sales transactions of the multiple retailers, and
the point-of-sale data is stored in association with a retailer identification identifying a specific retailer in the multiple retailers and a user authority level providing access permission to specific users of the user terminal.

7. The information processing system according to claim 1, further comprising:
the electronic receipt server.

8. The information processing system according to claim 1, wherein the processor is further configured to:
send coupon information to a point-of-sale device based on coupon inquiry from the point-of-sale device, the coupon inquiry including point-of-sale data for a sales transaction at the point-of-sale device.

9. The information processing system according to claim 8, wherein the point-of-sale data for the sales transaction included in the coupon inquiry is then stored in the storage device.

10. A sales data aggregation server, comprising:
a communication interface connectable to a network;
a storage device; and
a processor configured to:
receive point-of-sale data from a plurality point-of-sale devices via the network and store the point-of-sale data in the storage device;
receive receipt data from an electronic receipt server via the network and store the receipt data in the storage device;
generate display information based on stored point-of-sale data;
generate display information based on stored receipt data;
generate display information based on both the stored point-of-sale data and the stored receipt data; and
transmit generated display information to a user terminal via the network.

11. The sales data aggregation server according to claim 10, wherein
the plurality of point-of-sale devices generate the point-of-sale data for sales transactions of a single organization, and
the receipt data is for sales transactions of multiple organizations.

12. The sales data aggregation server according to claim 11, wherein the user terminal is operated by the single organization.

13. The sales data aggregation server according to claim 11, wherein the user terminal is operated by an entity other than the single organization.

14. The sales data aggregation server according to claim 13, the entity is a data analysis vendor granted use authority by the single organization.

15. The sales data aggregation server according to claim 10, wherein
the plurality of point-of-sale devices generate the point-of-sale data for sales transactions of multiple retailers,
the receipt data is for sales transactions of the multiple retailers, and
the point-of-sale data is stored in association with a retailer identification identifying a specific retailer in the multiple retailers and a user authority level providing access permission to specific users of the user terminal.

16. The sales data aggregation server according to claim 10, wherein the processor is further configured to:
send coupon information to a point-of-sale device based on coupon inquiry from the point-of-sale device, the coupon inquiry including point-of-sale data for a sales transaction at the point-of-sale device.

17. The sales data aggregation server according to claim 16, wherein the point-of-sale data for the sales transaction included in the coupon inquiry is then stored in the storage device.

18. A sales data information processing method for a sales data aggregation system, the method comprising:
receiving point-of-sale data from a plurality point-of-sale devices via a network and storing the point-of-sale data in a storage device;
receiving receipt data from an electronic receipt server via the network and storing the receipt data in the storage device;
generating display information based on both the stored point-of-sale data and the stored receipt data; and
transmitting generated display information to a user terminal via the network.

19. The sales data information processing method according to claim 18, wherein
the plurality of point-of-sale devices generate the point-of-sale data for sales transactions of a single organization, and
the receipt data is for sales transactions of multiple organizations.

20. The sales data information processing method according to claim 19, further comprising:
sending coupon information to a point-of-sale device based on coupon inquiry from the point-of-sale device, the coupon inquiry including point-of-sale data for a sales transaction at the point-of-sale device, wherein
the point-of-sale data for the sales transaction included in the coupon inquiry is then stored in the storage device.
